(19) United States
(12) Patent Application Publication
(10) Pub. No.: US 2026/0309605 A1
(43) Pub. Date: Oct. 8, 2026

(54) VIBRONIC MEASURING SYSTEM FOR A FLUID MEDIUM CONVEYED IN A PIPE

(71) Applicant: Endress+Hauser Flowtec AG, Reinach (CH)

(72) Inventors: Michael Kirst, Lörrach (DE); Alfred Rieder, Landshut (DE)

(21) Appl. No.: 19/483,151

(22) PCT Filed: Mar. 5, 2024
(86) PCT No.: PCT/EP2024/055664

§ 371 Date: Nov. 10, 2025

(30) Foreign Application Priority Data
May 10, 2023 (DE) 10 2023 112 374.2

(51) Int. Cl. G01N 9/00; G01F 1/84

(52) U.S. Cl. CPC G01N 9/002; G01F 1/8422; G01F 1/8427; G01F 1/8436; G01N 2009/006

(57) ABSTRACT

A measuring system includes a measuring transducer and measuring system electronics electrically connected to the measuring transducer, which includes a vibrating element configured to vibrate while in contact with a medium flowing therethrough, wherein the measuring system electronics are designed, in a first operating mode, to supply power to an exciter arrangement of the measuring transducer such that the vibrating element performs useful oscillations and to receive and evaluate a first sensor signal from a sensor arrangement of the measuring transducer, and, in a second operating mode, to stop supplying power to the exciter arrangement for a set duration and to receive and evaluate a second sensor signal so as to determine measurement values for a measurement variable of the flowing medium using the first sensor signal received during the first operating mode and to identify interference parameter values using the second sensor signal received during the second operating mode.

The invention relates to a vibronic measuring system formed by means of a vibration-type measuring transducer and measuring system electronics electrically connected thereto, e.g., having one or more microprocessors, in particular as a Coriolis mass flow measuring device or Coriolis mass flow/density measuring device or Coriolis mass flow/density/viscosity measuring device, and/or as a vibronic (flow) measuring system designed as in-line measuring devices in a compact design, for measuring and/or monitoring at least one measurement variable of a fluid measurement substance, in particular, namely, a gas, a liquid, or a dispersion and/or a measurement substance guided or flowing in a pipe (connected to the measuring system).

Vibronic measuring systems of the type in question have been known for a long time and have proven themselves in industrial use, not least also in the field of the regulation and monitoring of automated process-engineering processes or process systems or in the field of transfer points of the goods traffic, which may also be subject to calibration. A measurement variable that can be detected by means of such a measuring system can, for example, be a time-varying flow parameter, e.g., a mass flow (mass flow rate), a volume flow (volume flow rate) or a flow velocity, and/or a time-varying material parameter, e.g., a density and/or a viscosity, of the respective measurement substance and/or a (flow) characteristic number derived from one or more flow and/or material parameters—for example, a Reynolds number. Examples of vibronic measuring systems of the type in question are described for example, in EP-B 564 682, US-A 2015/0268082, US-A 2010/0011882, US-A 2010/0139416, US-A 2011/0146416, US-A 2011/0146416, US-A 2011/0271756, US-A 2011/0265580, US-A 2016/0033314, US-A 2016/0334316, US-A 2016/0349091, US-A 2020/0132529, US-A 2020/0408581, US-A 2021/0140804, US-A 2023/0037109, U.S. Pat. Nos. 4,420,983, 4,524,610, 5,392,656, 5,602,345, 5,736,653, 5,796,011, 5,796,012, 5,804,741, 5,926,096, 6,311,136, 9,372,107, 10,408,652, 10,598,534, 10,809,109, 11,073,416, 11,530,967, 6,557,422, WO-A 2015/155044, WO-A 2017/069749, WO-A 2019/017891, WO-A 2019/040089, WO-A 2019/081169, WO-A 2019/081170, US-A 2020/0408581, WO-A 2021/136626, WO-A 01/29519, WO-A 93/21505, WO-A 95/33981, WO-A 96/05484, or WO-A 96/08697 and have been manufactured for a long time, among others, by the applicant itself and offered as Coriolis mass flow measuring devices or as Coriolis mass flow/density measuring devices—for example, under the trade names “PROMASS G 100,” “PROMASS O 100,” “PROMASS E 200,” “PROMASS F 300,” “PROMASS X 500,” “CNGmass,” “LPGmass,” or “Dosimass” (https://www.endress.com/de/search?filter.text=promass).

The measuring transducer of each of the aforementioned measuring systems is designed to be connected (fluidically) to the pipe or to be inserted (measurement substance conductively) into the course of the pipe to form a corresponding (process) measuring point and in each case comprises at least one (tubular or plate-shaped) vibrating element, an electro-mechanical exciter arrangement electrically connected to the respective measuring system electronics for converting electrical power provided by the measuring system electronics into mechanical power useful for exciting and maintaining forced mechanical (useful) oscillations of the at least one vibrating element, as well as a sensor arrangement likewise electrically coupled to the measuring system electronics for detecting mechanical oscillations of the at least one vibrating element and for providing sensor signals representing oscillating movements of the at least one vibrating element. In the measuring systems disclosed, e.g., in U.S. Pat. Nos. 9,372,107 or 10,408,652, the measuring transducer has, for example, two vibrating elements, each of which can be selectively excited by means of the exciter arrangement and which may also have vibration properties or resonance frequencies that differ considerably from one another, the mechanical oscillations of which are also selectively detected by means of the sensor arrangement.

In modern measuring systems of the type in question, the measuring system electronics, as described, for example, in the aforementioned U.S. Pat. No. 6,311,136, are typically implemented by means of one or more microprocessors and/or one or more digital signal processors. Moreover, the measuring system electronics of a measuring system of the type in question are also regularly designed to be electrically connected to a superordinate electronic data processing system (EDP), e.g., formed by means of a programmable logic controller (PLC) and/or a process control system (PCS) and/or an edge (computing) device and/or a cloud (computing) system, e.g., for the purpose of transmitting (measuring system) data collected by means of the measuring system and/or for remote control and/or for power supply—for example, also via a (standard) fieldbus. In addition, the measuring system electronics can also be designed to communicate wirelessly by radio with the respective data processing system—for example, to transmit (measuring system) data wirelessly by radio to the respective data processing system. To protect the measuring system electronics from environmental influences, they are also usually accommodated within at least one comparatively robust, particularly impact-, pressure-, and/or weather-resistant, electronics housing. The electronics housing can, for example, be arranged remotely from the measuring transducer and connected thereto only via a flexible cable; however, it can also be arranged directly on the measuring transducer or on a measuring transducer housing, as also disclosed, for example, in the aforementioned U.S. Pat. No. 5,796,011. In addition, however, as disclosed, inter alia, in U.S. Pat. No. 9,372,107 or WO-A 01/29519, it is also quite common to use modular electronics, possibly also accommodated in two or more separate housing modules, to form a measuring system of the type in question.

The at least one vibrating element of each of the aforementioned measuring systems is specifically designed to come into contact with each measured substance to be measured, in particular for the measured substance to flow around or through it (flowing through the transducer in a flow direction), and to vibrate while in contact (driven by the respective exciter arrangement and the measuring system electronics electrically connected thereto); this is typically done in such a way that the at least one vibrating element is actively excited by the exciter arrangement to resonance oscillations in a natural oscillation mode suitable for measuring the respective measurement variable or generating Coriolis, inertial, or frictional forces dependent thereon, occasionally also referred to as the drive or useful mode, for the purpose of generating sensor signals influenced by the respective measurement variable to be measured or corresponding thereto. For this purpose, the exciter arrangement is correspondingly designed to convert the electrical power fed into it by the measuring system electronics into forced mechanical (useful) oscillations of the vibrating element around a static rest position (actively) exciting mechanical power. In addition, the sensor arrangement is designed to detect mechanical oscillations of the at least one vibrating element contacted by the measured substance around a static rest position, not least also the aforementioned useful oscillations (simultaneously with their active excitation), and to convert each into a sensor signal (of the sensor arrangement) representing oscillations of the respective vibrating element—for example, namely, a velocity of oscillating movements of the at least one vibrating element.

The exciter arrangement of each of the measuring transducers is formed by means of at least one (electrodynamic or piezoelectric) oscillation exciter that is to some extent mechanically connected to the respective vibrating element, while the sensor arrangement is formed by means of at least one, for example, optoelectronic, piezoelectric, or electrodynamic oscillation sensor that is also to some extent mechanically connected to the respective vibrating element, viz., an oscillation sensor having a permanent magnet and an (air) coil flooded by its magnetic field. Not least for the aforementioned case in which the measuring system is designed as a Coriolis mass flow measuring device, the sensor arrangement is formed by means of at least two spaced-apart, typically identical, oscillation sensors, viz., by means of a first oscillation sensor (on the inlet side) as well as at least one second oscillation sensor (spaced therefrom in a flow direction of the measuring transducer or of the measurement substance guided therein) on the outlet side, wherein each of the at least two oscillation sensors are designed to detect oscillating movements of the vibrating element and to convert them into a first or second sensor signal, in particular an electrical or optical one, representing said oscillating movements, e.g., with an electrical voltage dependent upon the oscillations of the vibrating element, which has both a signal frequency corresponding to the current vibration frequency of the vibrating element as well as a phase angle dependent upon the current mass flow (mass flow rate) of the measurement substance; this is done in particular in such a way that a relative phase difference exists between the sensor signal of the first oscillation sensor and the sensor signal of the second oscillation sensor, which depends upon the current mass flow. In the case of electrodynamic oscillation sensors, these can, as already indicated, for example, each be formed by means of a plunger coil electrically connected to the measuring system electronics, e.g., in such a way that its respective permanent magnetic armature is mechanically connected to the at least one vibrating element, and that its air coil (held at a distance from the respective armature) flooded by the magnetic field of the respective armature is electrically connected to the measuring system electronics.

Each of the aforementioned sensor signals is, as already indicated, also fed to the measuring system electronics of the respective measuring system, which in turn serve, inter alia, to receive and evaluate sensor signals supplied by the sensor arrangement, in particular, namely, to identify the (digital) measurement values representing at least one measurement variable. In addition to evaluating the sensor signals of the sensor arrangement or the transducer formed thereby, the measuring system electronics, as already indicated, also serve, inter alia, to control the transducer, in particular its exciter arrangement; this is done in particular in such a way that, at least during normal measuring operation of the measuring system, the at least one vibrating element of the transducer is at least temporarily excited to useful oscillations, viz., forced mechanical oscillations with at least one (useful) frequency, by means of the exciter arrangement and the measuring system electronics connected thereto for the purpose of generating the aforementioned sensor signals. Accordingly, the measuring system electronics are further also designed to generate at least one electrical driver signal, e.g., harmonic and/or clocked, serving to feed electrical energy into the exciter arrangement for the at least one oscillation exciter acting upon the vibrating element or the exciter arrangement formed thereby. The driver signal can, for example, be designed as a broadband signal with a signal component with a signal frequency matching the intended useful frequency or, for example, as a rather narrowband or harmonic signal with a single dominant signal component of a matching signal frequency. Said signal component or the driver signal as a whole can also be regulated, for example, with regard to a current strength and/or a voltage level. In measuring systems of the type in question, a natural current resonance frequency of the vibrating element is typically selected as the useful frequency, which in turn depends substantially upon a natural frequency of the vibrating element, determined, inter alia, by the size, shape, and material of the vibrating element, as well as on an current density and a current viscosity of the medium or measurement substance contacting the vibrating element. Typically, such resonance frequencies serving as useful frequencies of vibrating elements of the type in question lie within a frequency range between 50 Hz (Hertz) and a maximum of 2 kHz. Due to the fluctuating density and/or viscosity of the respective measurement substance and/or due to changes of measurement substance carried out during operation of the measuring system, the respective resonance frequency and thus the corresponding respective useful frequency is naturally variable within a predetermined, in particular, namely, calibrated or specified, (useful) frequency band having lower and upper limit frequencies of the respective measuring system. Based upon the currently excited useful frequency, viz., corresponding to the current resonance frequency of the vibration element (lying within the aforementioned useful frequency band), such measuring systems can also be correspondingly used to measure the density of the measurement substance or to identify measured values for other substance and/or flow parameters dependent thereon.

As disclosed, inter alia, in EP-B 564 682, U.S. Pat. Nos. 4,420,983, 5,392,656, US-A 2016/0334316, U.S. Pat. No. 11,530,967, WO-A 2015/155044, WO-A 95/33981, or U.S. Pat. No. 9,372,107, the at least one vibrating element can, for example, be a (plate-shaped or rod-shaped) immersion body which is arranged at least to some extent within a lumen of a partial segment of the pipe or within a lumen of a tube of the measuring transducer inserted into the course of the pipe (serving as a flow-through measuring cell).

In the measuring systems disclosed in US-A 2015/0268082, US-A 2010/0011882, US-A 2010/0139416, US-A 2011/0271756, US-A 2011/0146416, US-A 2011/0146416, US-A 2011/0265580, US-A 2016/0033314, US-A 2016/0349091, US-A 2020/0132529, US-A 2020/0408581, US-A 2021/0140804, US-A 2023/0037109, U.S. Pat. Nos. 4,524,610, 5,602,345, 5,736,653, 5,796,011, 5,796,012, 5,804,741, 5,926,096, 6,311,136, 6,557,422, 7,325,462, 7,353,717, 9,372,107, 10,408,652, 10,598,534, 10,809,109, 11,073,416, WO-A 2017/069749, WO-A 2019/017891, WO-A 2019/040089, WO-A 2019/081169, WO-A 2019/081170, WO-A 2021/136626, WO-A 96/05484, or WO-A 96/08697, the at least one vibrating element is designed as a (measuring) tube arrangement serving to guide flowing measurement substance—occasionally also referred to as (transducer) inner part—in such a way that the at least one vibrating element has one or more (measuring) tubes, each at least sectionally straight and/or at least sectionally curved. To protect against external influences, the vibrating element formed by the aforementioned tube arrangement is in a typically metallic transducer housing together with the excitation and sensor arrangement. In the case of measuring systems disclosed in WO-A 96/08697 or WO-A 2019/017891, the transducer housing and the respective vibration element are in particular releasably connected to each other, e.g., to enable subsequent insertion of the vibration element formed by means of such a tube arrangement or replacement of a defective or worn vibration element with an intact vibration element (of the same design) on-site. In addition, in the case of electrodynamic oscillation exciters and/or oscillation sensors, their respective (air) coils can be directly fixed to the transducer housing. Alternatively or in addition, the aforementioned electronics housing can be mounted directly on the aforementioned transducer housing, e.g., namely, removably fixed thereto, to form a Coriolis mass flow measuring device or a Coriolis mass flow/density measuring device in a compact design.

The aforementioned vibration elements, each designed as a (measuring) tube arrangement, are each in particular provided to be integrated (directly) into the course of a process line serving to guide the respective measurement substance, and each have at least one (measuring) tube—for example, exactly one (measuring) tube or exactly two (measuring) tubes or exactly four (measuring) tubes—which in each case extends from a respective first tube end to a respective second tube end with a tube length and has a lumen enclosed by a typically metallic tube wall and extending from the first tube end to the second tube end. The (measuring) tubes of marketed (standard) Coriolis mass flow/density measuring devices typically have at least two planes of symmetry orthogonal to one another and may, for example, have a U- or V- or a rectangular or triangular shape, and even more rarely also an Ω or helical shape. Moreover, the respective tube wall thereof typically consists of a steel, for example, i.e., a stainless steel, duplex steel, or super duplex steel, of a titanium alloy, a zirconium alloy, e.g., a Zircaloy, and/or a tantalum alloy. The tube length of such (measuring) tubes can be in a range between approximately 100 mm and 2,000 mm, and a caliber (inner tube diameter) of such tubes can be in the range between approximately 0.1 mm and approximately 100 mm, typically such that the respective tube has a caliber-to-tube length ratio in the range between approximately 0.08 and 0.25.

In the case of transducers with a single (measuring) tube forming the vibration element, the latter usually communicates with the aforementioned process line via a substantially straight connecting tube piece (of the respective vibration element) opening into the inlet side and via a substantially straight connecting tube piece (of the respective vibration element) opening into the outlet side. Furthermore, the vibration element of such transducers with a single (measuring) tube respectively comprises at least one single-piece or multi-part, e.g., tubular, box-shaped, or plate-shaped counter-oscillator, which is coupled to the tube on the inlet side to form a first coupling zone and which is coupled to the tube on the outlet side to form a second coupling zone, and which substantially rests in operation or is made to oscillate in opposition to the tube, i.e., at the same frequency and in phase opposition. A vibrating element formed by a (measuring) tube and counter-oscillator is usually held so as to be able to oscillate in the respective transducer housing solely by means of the two connecting tube pieces described above. In the case of the (standard) transducers shown, for example, in U.S. Pat. Nos. 5,291,792, 5,796,010, 5,945,609, 7,077,014, US-A 2007/0119264, WO-A 01/02816, or also WO-A 99/40394, with a single, substantially straight (measuring) tube, the latter and the counter-oscillator are aligned substantially coaxially with one another, as is quite usual in conventional transducers. Comparatively cost-effective steel grades, such as construction steel or machining steel, are usually used as materials for such a counter-oscillator, not least also when titanium, tantalum, or zirconium are used for the (measuring) tube. In the case of the use of two or more (measuring) tubes, these can be connected in parallel in terms of flow, as shown, inter alia, in U.S. Pat. Nos. 5,602,345, 5,796,011, US-A 2011/0146416, US-A 2011/0265580, or WO-A 96/08697, in each case by means of inlet and outlet-side flow dividers, in that a first of the (measuring) tubes is connected by an inlet-side first (measuring) tube end into a first flow opening of a first flow divider (on the inlet side or serving as a line branch) and by an outlet-side second (measuring) tube end into a first flow opening of a second (outlet-side or serving as a line union) flow divider, and a second of the (measuring) tubes opens by an (inlet-side) first (measuring) tube end into a second flow opening of the first flow divider and by an (outlet-side) second (measuring) tube end into a second flow opening of the second flow divider. In the case of U.S. Pat. No. 10,408,652, US-A 2011/0146416, US-A 2011/0265580, and WO-A 96/08697, a third of the (measuring) tubes opens by an (inlet-side) first (measuring) tube end into a third flow opening of the first flow divider and by an (outlet-side) second (measuring) tube end into a third flow opening of the second flow divider, and a fourth of the (measuring) tubes opens by an (inlet-side) first (measuring) tube end into a fourth flow opening of the first flow divider and by an (outlet-side) second (measuring) tube end into a fourth flow opening of the second flow divider. Each of the flow dividers may further have a connecting flange with a sealing surface for fluid-tight connection of the measuring transducer to a line segment of the pipe serving to supply medium or to discharge medium from the measuring transducer. The flow dividers can, for example, be designed as an integral component of the aforementioned transducer housing. Each of the aforementioned flow dividers or each of the aforementioned connecting tube pieces of commercially available measuring transducers is typically also equipped with a (standard) connection flange serving to connect to the respective process line.

Each of the aforementioned (measuring) tubes forming the at least one vibrating element is, as already indicated, also in particular designed for the measurement substance that is supplied or discharged via the connected process line to flow through at least in a flow direction pointing from the respective first tube end to the respective second tube end during (measuring) operation of the measuring system, and to be allowed to vibrate during this (driven by at least one oscillation exciter of the respective exciter arrangement); this applies to the aforementioned case where the measuring system is designed as a Coriolis mass flow measuring device, and the vibrating element is designed as a tube arrangement, typically in such a way that at least the useful oscillations of the vibrating element excited by means of the at least one oscillation exciter or detected by means of the at least one oscillation sensor are at least to some extent such lateral bending oscillations of at least one of the (measuring) tubes about its respective static rest position, which are suitable for causing Coriolis forces in the measurement substance flowing through said (measuring) tube, which superimpose (Coriolis) vibrations of the same frequency as the useful vibrations. In vibrating elements formed by means of a tube arrangement of conventional (standard) Coriolis mass flow measuring devices, the at least one vibration exciter is typically also designed and arranged in such a way that a time-varying driving force generated thereby acts upon the respective tube practically only at a point at a drive point formed by means of the vibration exciter on the (measuring) tube mechanically connected thereto. In the case of a vibrating element formed by means of two (measuring) tubes, the at least one oscillation exciter is typically designed as a differential oscillation exciter, viz., one that introduces excitation forces acting along a common line of action but in opposite directions into the (measuring) tubes, and/or the useful oscillations are also typically designed as opposite bending oscillations. For the other aforementioned case in which the (measuring) tube assembly forming the vibration element has a counter-oscillator, the oscillation exciter can be to some extent fastened thereto in such a way that the oscillation exciter differentially acts upon the measuring tube and counter-oscillator. Alternatively, the oscillation exciter can for example also be attached to some extent to the aforementioned transducer housing. Likewise, the oscillation sensors can also be designed as differential oscillation sensors, viz., oscillation sensors that only detect relative or opposite oscillations of the (measuring) tubes or of the single (measuring) tube and the counter-oscillator.

Not least, in commercially available (Standard) Coriolis mass flow measuring devices, the respective exciter arrangements, as also disclosed in U.S. Pat. Nos. 5,602,345, 5,796,010, 6,840,109, 7,077,014 or U.S. Pat No. 7,017,424, US-A 2014/0352454, WO-A 93/01472, WO-A 2005/050145, WO-A 2013/002759, WO-A 2011/019345, are typically also designed so that each of the (measuring) tubes is (to some extent) connected to exactly one oscillation exciter, in such a way that the exciter arrangement has no further oscillation exciter connected to the respective (measuring) tube apart from the (one) oscillation exciter, and/or the oscillation exciter is typically of the electrodynamic type, viz., formed by means of a voice coil, e.g., in such a way that its magnetic armature is mechanically connected to the at least one (measuring) tube to form the drive point, and that its air coil flooded by the magnetic field of the armature is electrically connected to the measuring system electronics and mechanically connected to the other tube or the counter-oscillator of the tube arrangement or to the transducer housing. Nevertheless, vibronic measuring systems are also known, for example, from WO-A 2017/069749, WO-A 2017/019016, WO-A 2006/036139, U.S. Pat. No. 5,926,096, WO-A 99/28708, WO-A 99/44018, WO-A 99/02945, US-A 2020/0132529, U.S. Pat. Nos. 4,831,885, 6,557,422, 6,092,429, or also 4,823,614, in which the exciter assembly has two or more vibration exciters respectively connected to one and the same tubes of the respective tube assembly and/or formed by means of one or more piezo elements.

To define a free oscillation length of each of the (measuring) tubes and, associated therewith, to adjust the resonance frequency to be excited or the respective useful frequency band (of the measuring system), tube arrangements with two or four tubes serving as vibrating elements furthermore usually comprise at least one (inlet-side) first coupler element for forming inlet-side oscillation nodes for opposite oscillations, in particular bending oscillations, of both (measuring) tubes, which is fixed to the (measuring) tubes at a distance from both flow dividers, as well as at least one (outlet-side) second coupler element for forming outlet-side oscillation nodes for (opposite) oscillations, in particular (opposite) bending oscillations, of the (measuring) tubes, which is fixed to the (measuring) tubes at a distance from both flow dividers as well as from the inlet-side coupler element. By means of the coupler elements, the oscillation quality of the pipe arrangement or the (measurement) sensitivity of the measuring transducer as a whole can also be influenced.

As discussed, among others, in the aforementioned U.S. Pat. No. 5,736,653, vibronic measuring systems of the type in question can also exhibit cross-sensitivities to externally excited mechanical interference oscillations—occasionally also referred to as (process) noise—viz., not generated by the respective exciter arrangement or merely from outside the measuring system, that have an oscillation frequency corresponding to the aforementioned resonance frequencies of the vibrating element or of the measuring transducer formed thereby; this is also done in particular in such a way that the measuring accuracy of the measuring system or the functionality of the measuring system as a whole is at least temporarily impaired, e.g., in such a way that, namely, the measurement values identified for the mass flow rate also deviate to a considerable, albeit unforeseeable, extent from the actual mass flow rate, possibly also accompanied by a comparatively high degree of scatter, or such that said measurement values exhibit a correspondingly excessive measurement error or a correspondingly insufficient reproducibility. Interference sources causing such interference oscillations can, for example, be vibrating pumps and/or valves that are mechanically coupled to the respective measuring transducer via a pipe. In addition, as also described, inter alia, in the aforementioned U.S. Pat. Nos. 6,311,136 or 10,809,109, for example, the flowing measurement substance itself can establish a source of interference for interference oscillations of the type in question, e.g., in such a way that the measurement substance flowing through the measuring transducer, depending upon its mass flow and/or foreign substances conveyed in the measurement substance, excites oscillations of the vibrating element on one or more of its resonance frequencies—for example, also an intended useful frequency. Accordingly, it can be assumed that, in the case of measuring systems of the type in question, during operation, they can occasionally be operated within a risk frequency range (of the measuring point) determined by the respective application or by the measuring point formed by means of the respective measuring system and which comprises one or more interference frequencies, in such a way that said risk frequency range at least to some extent corresponds to the aforementioned useful frequency band (of the measuring system), or such that at least one of the interference frequencies corresponds at least approximately to the intended or actually excited useful frequency.

In order to also detect the aforementioned interference oscillations during ongoing operation, the sensor arrangements of the measuring systems disclosed in U.S. Pat. No. 5,736,653 have, in addition to the aforementioned two, for example, (standard) oscillation sensors each detecting the velocity of oscillation movements of the at least one vibration element, two further (additional) vibration sensors detecting, for example, the accelerations of oscillation movements of the at least one vibration element. In addition, the respective measuring system electronics are also designed to identify a mass flow measurement signal free of interference (resulting from interference oscillations of the aforementioned type) or, accordingly, error-free measurement values for the mass flow of the respective measurement substance using the sensor signals of all four oscillation sensors. One disadvantage of such a solution is, inter alia, however, that the use of such (additional) oscillation sensors requires, on the one hand, increased technical effort with regard to the construction of both the measuring transducer and the measuring system electronics, in such a way that the costs of the respective sensor arrangement as well as the (hardware) costs for the signal processing are approximately twice as high in comparison to those of a standard measuring system. On the other hand, the increased number of oscillation sensors naturally also accordingly increases the risk of a failure of the sensor arrangement, resulting in a total failure of the measuring system formed thereby. A further disadvantage of the aforementioned solution is in addition that it is also only applicable to those measuring transducers in which the vibrating element is formed by means of a single (measuring) tube and a counter-oscillator coupled thereto.

Based upon the aforementioned prior art, one object of the invention is to improve vibronic measuring systems such that any interference oscillations or interference sources causing them in the region of the respective measuring point (formed by means of such a measuring system) can be detected economically as early and reliably as possible, and if applicable, reported; this also holds true in particular when using the (standard) measuring transducers or typical vibrating elements established for conventional measuring systems of the type in question, as well as also while equally still maintaining proven technologies and architectures of already established measuring system electronics.

To achieve the object, the invention consists of a vibronic measuring system, e.g., a Coriolis mass flow measuring device and/or a density measuring device and/or a viscosity measuring device, for measuring one or more measurement variables, e.g., a density, a viscosity, a mass flow, and/or a volume flow, of a fluid measurement substance, e.g., a gas, a liquid, or a dispersion, conveyed in a pipe (connected thereto), which measuring system comprises:
a (vibronic) measuring transducer with at least one vibrating element, e.g., having at least one (measuring) tube or formed thereby, with an exciter arrangement formed by means of at least one, e.g., electrodynamic or piezoelectric, oscillation exciter, and with a sensor arrangement formed by means of at least one, e.g., electrodynamic, optoelectronic, or piezoelectric, oscillation sensor;
as well as measuring system electronics electrically connected to the measuring transducer, e.g., both to the exciter arrangement and the sensor arrangement for example, formed by means of one or more microprocessors;
wherein the measuring transducer is designed to be (fluidically) connected to the pipe or inserted into the course of the pipe;
wherein the at least one vibrating element is designed to come into contact with the measurement substance, e.g., namely, be flowed around or through, and to vibrate while in contact;
wherein the at least one oscillation exciter or the exciter arrangement formed thereby is designed to convert supplied electrical power into forced mechanical (useful) oscillations of the at least one vibrating element around a static rest position (actively) exciting mechanical power;
wherein the at least one oscillation sensor or the sensor arrangement formed thereby is designed to detect mechanical oscillations of the at least one vibrating element about a static rest position and to convert them into a (first) sensor signal (of the sensor arrangement) representing oscillations of the vibrating element—for example, namely, a velocity of oscillating movements of the vibrating element;
wherein the measuring system electronics are designed, in a first operating mode (active mode), both to supply power to the exciter arrangement, viz., to feed an electrical driver signal, e.g., having a signal frequency that is predeterminable and/or corresponds to a current resonance frequency fR of the measuring transducer and/or having a predeterminable signal amplitude, into the at least one oscillation exciter, in such a way that the vibrating element, at least during a first measuring interval, performs useful oscillations at least to some extent, viz., forced mechanical oscillations with at least one useful frequency, e.g., corresponding to a current resonance frequency fR of the measuring transducer and/or not less than 50 Hz (Hertz) and/or not more than 2 kHz, and the sensor signal at least to some extent represents the useful oscillations of the vibrating element, and to receive and evaluate the at least one (first) sensor signal;
wherein the measuring system electronics are designed, in a second operating mode (passive mode), both not to supply power to the exciter arrangement for a set, for example, adaptable and/or not less than 1 s (second), duration Tnexc, e.g., in such a way that the at least one vibrating element does not perform any useful oscillations (excited by the exciter arrangement) at least during a second measuring interval, and/or that useful oscillations of the at least one vibrating element (previously excited by the exciter arrangement) have decayed at least during a second measuring interval, as well as to receive and evaluate the at least one sensor signal representing, for example, (only) passive oscillations or (only) oscillations of the at least one vibrating element excited from outside the measuring transducer;
and wherein the measuring system electronics are designed both to identify (digital) measurement values for at least one measurement variable by using the at least one (first) sensor signal (of the sensor arrangement) received during the first operating mode, e.g., namely, a spectral (useful) signal component with a signal frequency corresponding to the useful frequency, and, by using the at least one (first) sensor signal received during the second operating mode, to identify one or more, for example, digital, (interference) parameter values for at least one interference parameter (of the measuring system or a measuring point formed thereby), e.g., an (interference) frequency and/or an (interference) amplitude, which, for example, influences the functionality and/or measurement accuracy of the measuring system—for example, namely, to identify an (interference) frequency spectrum of (externally excited) interference oscillations of the measuring system or a measuring point formed thereby and/or to calculate one or more measurement values for at least one measurement variable using one or more (interference) parameter values of the at least one interference parameter.

According to a first embodiment of the invention, it is further provided that the at least one interference parameter represent an (externally excited) (fluid-)mechanical interference oscillation coupled into the measuring system, e.g., via a pipe and/or via a fluid conveyed in the pipe—for example, namely, a frequency of the interference oscillation and/or an amplitude of the interference oscillation.

According to a second embodiment of the invention, it is further provided that one or more (interference) parameter values represent, e.g., quantify, one or more (interference) amplitudes of one or more (externally excited) mechanical (interference) oscillations coupled into the measuring system—for example, via a pipe and/or via a fluid conveyed in the pipe.

According to a third embodiment of the invention, it is further provided that one or more (interference) parameter values represent, e.g., quantify, one or more (interference) frequencies of one or more (externally excited) mechanical (interference) oscillations for example, coupled into the measuring system via a pipe and/or via a fluid conveyed in the pipe and/or that is generated by a fluid flowing through the measuring transducer. According to a fourth embodiment of the invention, it is further provided that the duration Tnexc be (set to be) greater than 2 s (seconds)—for example, not less than 5 s.

According to a fifth embodiment of the invention, it is further provided that the measuring system electronics be designed to activate or execute the second operating mode after the first operating mode—for example, namely, to identify a cause of reduced functionality of the measuring system and/or to identify a cause of reduced measurement accuracy of the measuring system and/or to identify a cause of a failure of the measuring system.

According to a sixth embodiment of the invention, it is further provided that the at least one vibrating element have a (decay) time constant which is dependent upon a (modal) quality factor Q1, e.g., of more than 5,000, of the vibrating element at the (last excited) useful frequency fN—for example, namely, corresponding to a ratio Q1/f1 of the quality factor Q1 relative to the (last excited) useful frequency fN. Developing this embodiment of the invention, the quality factor Q1* of the at least one vibrating element is greater than 5,000, e.g., not less than 10,000, and/or the duration Tnexc is (set to be) greater than 5 times the (decay) time constant and/or (set to be) greater than 50 s, e.g., greater than 1 min (minute), and/or the useful frequency fN is more than 50 Hz and/or less than 2 kHz—for example, more than 200 Hz and less than 1,500 Hz.

According to a seventh embodiment of the invention, it is further provided that the at least one vibrating element have a (decay) time constant which is dependent upon a (modal) quality factor Q1, e.g., of more than 5,000, of the vibrating element at the (last excited) useful frequency fN, e.g., namely, corresponding to a ratio Q1/f1 of the quality factor Q1 in relation to the (last excited) useful frequency fN, and that the measuring system electronics be designed to activate or execute the second operating mode after the first operating mode—for example, namely, to identify a cause of reduced functionality of the measuring system, and/or to identify a cause of reduced measurement accuracy of the measuring system, and/or to identify a cause of a failure of the measuring system. Developing this embodiment of the invention, it is further provided that the duration Tnexc be (selected to be) greater than the (decay) time constant (of the vibrating element)—for example, more than 3 times the (decay) time constant and/or greater than 20 s.

According to an eighth embodiment of the invention, it is further provided that the measuring system electronics be designed to activate or execute the second operating mode prior to the first operating mode, e.g., namely, for the (passive) calibration of a measuring point formed by means of the measuring system (involving the at least one vibrating element or the measuring transducer formed thereby) and/or during a (re-)commissioning of the measuring system. Developing this embodiment of the invention, it is further provided that the duration Tnexc be (set) less than 60 s—for example, not greater than 30 s.

According to a ninth embodiment of the invention, it is further provided that the measuring system electronics be designed to use measurement data collected during the second operating mode, e.g., one or more of the (interference) parameter values, during the first operating mode—for example, to identify one or more of the measurement values, and/or to check the functionality of the measuring system, and/or to check the measurement accuracy of the measuring system.

According to a tenth embodiment of the invention, it is further provided that the measuring system electronics be designed to provide the driver signal in the first operating mode with at least one predetermined signal frequency—for example, an adjustable one and/or corresponding to a mechanical resonance frequency of the vibrating element or the measuring transducer formed thereby and/or serving to set the useful frequency fN. Developing this embodiment of the invention, the measuring system electronics are further designed to set the signal frequency of the driver signal in the first operating mode using the at least one (first) sensor signal received during the first operating mode, e.g., namely, based upon a spectral (useful) signal component with a signal frequency corresponding to the useful frequency fN, and/or the measuring system electronics are further designed to check, in the first operating mode, using one or more (interference) parameter values, whether the at least one signal frequency of the driver signal or the useful frequency fN of the useful oscillations of the at least one vibrating element lies within a (risk) frequency range (of the measuring system or a measuring point formed thereby) containing (interference) frequencies of one or more interference oscillations—for example, namely, if applicable, to output a (warning) message signaling this and/or an (error) report indicating one or more interference sources (causing interference oscillations), and/or to deactivate the measuring system (at least temporarily).

According to an eleventh embodiment of the invention, it is further provided that the measuring system electronics be designed to identify at least one (current) resonance frequency of the measuring transducer, e.g., namely, its vibrating element, or of the measuring system formed thereby, using the at least one (first) sensor signal received during the first operating mode, e.g., namely, to identify one or more digital (measuring system) parameter values representing said resonance frequency based upon the at least one (first) sensor signal received during the first operating mode, and/or to check, using the at least one (first) sensor signal received during the second operating mode or one or more (interference) parameter values obtained therefrom, whether the at least one (current) resonance frequency (of the measuring transducer) lies within a (risk) frequency range (of the measuring system or a measuring point formed thereby) containing (interference) frequencies of one or more interference oscillations.

According to a twelfth embodiment of the invention, it is further provided that the measuring system electronics be designed to identify an (interference) frequency spectrum of (externally excited) interference oscillations of the measuring system or of a measuring point formed thereby (involving the at least one vibrating element or the measuring transducer formed thereby) using the at least one (first) sensor signal received during the second operating mode or one or more (interference) parameter values obtained therefrom.

According to a thirteenth embodiment of the invention, it is further provided that the measuring system electronics be designed to identify, using the at least one (first) sensor signal received during the second operating mode or one or more interference parameter values obtained therefrom, at least one usable frequency range (of the measuring system or a measuring point formed thereby), viz., one which contains no detectable or detected interference oscillations—for example, in such a way that an upper range limit of the usable frequency range and/or a lower range limit of the usable frequency range are identified on the basis of one or more of the (interference) parameter values.

According to a fourteenth embodiment of the invention, it is further provided that the measuring system electronics be designed to check, using the at least one (first) sensor signal received during the second operating mode or one or more (interference) parameter values obtained therefrom, whether one or more (nominal) mechanical resonance frequencies of the measuring transducer or of the measuring system formed thereby lie within a usable frequency range (of the measuring system or of a measuring point formed thereby) containing no detectable or detected (interference) frequencies of one or more interference oscillations—for example, namely, if applicable, to output an (enable) message signaling this and/or enabling the first operating mode, and/or to automatically switch to the first operating mode.

According to a fifteenth embodiment of the invention, it is further provided that the measuring system electronics be designed to vary, in the first operating mode, a signal frequency, determining the useful frequency, of the driver signal within a predetermined (useful) frequency band—for example, corresponding to a predetermined density measuring range of the measuring system.

According to a sixteenth embodiment of the invention, it is further provided that the measuring system electronics be designed to identify at least one (risk) frequency range (of the measuring system or a measuring point formed thereby) containing (interference) frequencies of one or more interference oscillations using the at least one (first) sensor signal received during the second operating mode or one or more (interference) parameter values obtained therefrom—for example, in such a way that an upper range limit of the (risk) frequency range and/or a lower range limit of the (risk) frequency range are identified on the basis of one or more of the (interference) parameter values. Developing this embodiment of the invention further, the measuring system electronics are further designed to check, using the at least one (first) sensor signal received during the second operating mode or one or more (interference) parameter values obtained therefrom, whether one or more (nominal) mechanical resonance frequencies of the measuring transducer or of the measuring system formed thereby lie within the (risk) frequency range (of the measuring system or of a measuring point formed thereby)—for example, if applicable, to output a (warning) message signaling this and/or an (error) report identifying one or more interference sources (causing interference oscillations), and/or to block the first operating mode (at least temporarily) or to deactivate the measuring system (at least temporarily).

According to a seventeenth embodiment of the invention, it is further provided that the measuring system electronics be designed to vary, in the first operating mode, a signal frequency, determining the useful frequency, of the driver signal within a predetermined (useful) frequency band, e.g., corresponding to a predetermined density measuring range of the measuring system, and to identify at least one (interference) frequency range (of the measuring system or a measuring point formed thereby) containing (interference) frequencies of one or more interference oscillations using the at least one (first) sensor signal received during the second operating mode or one or more (interference) parameter values obtained therefrom—for example, in such a way that an upper range limit of the (risk) frequency range and/or a lower range limit of the (risk) frequency range are identified based upon one or more of the (interference) parameter values. Developing this embodiment of the invention, the measuring system electronics are further designed to identify—for example, in the second operating mode—whether the (useful) frequency band and the (risk) frequency range coincide at least to some extent—for example, namely, to output a (warning) message signaling this, and/or to block the first operating mode (at least temporarily) or to deactivate the measuring system (at least temporarily).

According to an eighteenth embodiment of the invention, it is further provided that the measuring system electronics be designed to subject at least the at least one (first) sensor signal received during the second operating mode to a spectral analysis, e.g., a Fourier analysis—for example, based upon a (fast) discrete Fourier transformation (DFT).

According to a nineteenth embodiment of the invention, it is further provided that the measuring system electronics be designed to perform a modal analysis for a measuring point involving the at least one vibrating element or the measuring transducer formed thereby, at least on the basis of the at least one (first) sensor signal received during the second operating mode.

According to a twentieth embodiment of the invention, it is further provided that the measuring system electronics be designed to set a, for example, adaptive, (digital) filter using the at least one (first) sensor signal received during the second operating mode or one or more (interference) parameter values obtained therefrom, e.g., namely, to adapt to an (interference) frequency spectrum of (externally excited) interference oscillations of the measuring system or a measuring point formed thereby, in such a way that the filter is designed to suppress or block (interference) signal components contained in the at least one sensor signal and resulting from one or more of the interference oscillations. Developing this embodiment of the invention, the measuring system electronics are further designed to filter the at least one (first) sensor signal received during the first operating mode by means of the filter—for example, to block (interference) signal components contained in said sensor signal.

According to a twenty-first embodiment of the invention, it is further provided that the measuring system electronics be designed to identify, using the at least one sensor signal received during the first operating mode, one or more digital (measuring system) parameter values representing a (current) resonant frequency of the measuring transducer or of the measuring system formed thereby, and that the measuring system electronics be designed to check, using one or more, for example, non-volatilely stored, (measuring system) parameter values and one or more, for example, non-volatilely stored, (interference) parameter values, e.g., namely, by means of comparing one or more (interference) parameter values with one or more (measuring system) parameter values, whether the at least one resonant frequency of the vibrating element lies within a (risk) frequency range (of the measuring system or of a measuring point formed thereby) containing (interference) frequencies of one or more interference oscillations for example, namely, if applicable, to output a (warning) message signaling this and/or to output an (error) report indicating one or more interference sources (causing interference frequencies), and/or to deactivate the measuring system (at least temporarily).

According to a twenty-second embodiment of the invention, it is further provided that the at least one oscillation exciter be an electrodynamic oscillation exciter (formed by means of a voice coil).

According to a twenty-third embodiment of the invention, it is further provided that the at least one oscillation sensor be an electrodynamic oscillation sensor (formed by means of a plunger coil).

According to a twenty-fourth embodiment of the invention, it is further provided that the at least one sensor signal represent a velocity of oscillatory movements of the vibrating element.

According to a twenty-fifth embodiment of the invention, it is further provided that the oscillation sensor and the oscillation exciter be designed to be functionally identical—for example, structurally identical.

According to a twenty-sixth embodiment of the invention, it is further provided that the at least one oscillation sensor be spaced apart from the oscillation exciter—for example, in the direction of a (main) flow axis of the vibrating element and/or the measuring transducer formed thereby.

According to a twenty-seventh embodiment of the invention, it is further provided that the at least one vibrating element have or be formed with at least one (measuring) tube, e.g., one that is at least sectionally straight and/or at least sectionally curved, e.g., in such a way that the at least one (measuring) tube is designed for the measured substance to flow through it and to vibrate during this, and that the (useful) oscillations of the vibrating element excited by means of the at least one oscillation exciter or detected by means of the at least one oscillation sensor be at least to some extent bending oscillations of the at least one (measuring) tube. Further developing this embodiment of the invention, it is further provided that the sensor arrangement of (vibration) sensors, each of which is designed to detect mechanical oscillations of the at least one vibrating element and to convert them into a sensor signal (of the sensor arrangement) representing oscillations of the vibrating element, e.g., namely, a velocity of oscillating movements of the vibrating element, have a total of no more than twice the number of (measuring) tubes (of the vibrating element or of the measuring transducer formed thereby), and/or that the sensor arrangement of (vibration) sensors, each of which is designed to detect mechanical oscillations of the measuring transducer and to convert them into a sensor signal (of the sensor arrangement) representing oscillations of the measuring transducer, have a total of no more than twice the number of (measuring) tubes (of the vibrating element or of the measuring transducer formed thereby). Alternatively or additionally, the at least one vibrating element can further have at least one further (measuring) tube, e.g., in such a way that the (structurally identical) at least two (measuring) tubes of the vibrating element are connected (fluidically) in parallel to one another and/or are designed for the measurement substance to simultaneously flow through them and to vibrate (in opposite directions) during this.

According to a twenty-eighth embodiment of the invention, it is further provided that the at least one vibrating element have or be formed with at least one (measuring) tube, e.g., one that is at least sectionally straight and/or at least sectionally curved, e.g., in such a way that the at least one (measuring) tube is designed for the measured substance to flow through it and to vibrate during this, and that the (useful) oscillations of the vibrating element excited by means the at least one oscillation exciter or detected by means the at least one oscillation sensor be at least to some extent bending oscillations of the at least one (measuring) tube, and that the at least one vibrating element have at least one further (measuring) tube, e.g., in such a way that the (structurally identical) at least two (measuring) tubes of the vibrating element are connected (fluidically) in parallel to one another and/or are designed for the measured substance to flow through them simultaneously and to be allowed to vibrate (in opposite directions) during this. Developing this embodiment of the invention, it is further provided that the (useful) oscillations of the vibrating element excited by means of the at least one oscillation exciter or identified by means of the at least one oscillation sensor be at least to some extent (opposite) bending oscillations of the at least two (measuring) tubes.

According to a twenty-ninth embodiment of the invention, it is further provided that the at least one vibrating element have or be formed with a, for example, plate-shaped or rod-shaped, immersion body, e.g., in such a way that the immersion body is arranged at least to some extent within a lumen of a partial segment of the pipe or within a lumen of a tube of the measuring transducer inserted into the course of the pipe and is designed for the measurement substance to flow around it and to be allowed to vibrate during this.

According to a thirtieth embodiment of the invention, it is further provided that the sensor arrangement have at least one further (second) oscillation sensor—for example, structurally identical to the first oscillation sensor and/or electrodynamic, optoelectronic, or piezoelectric.

According to a thirty-first embodiment of the invention, it is further provided that the sensor arrangement have at least one further (second) oscillation sensor, e.g., structurally identical to the first oscillation sensor and/or electrodynamic, optoelectronic, or piezoelectric, and that the further (second) oscillation sensor be electrically connected to the measuring system electronics—for example, in the same way as the (first) oscillation sensor.

According to a thirty-second embodiment of the invention, it is further provided that the sensor arrangement have at least one further (second) oscillation sensor, e.g., structurally identical to the first oscillation sensor and/or electrodynamic, optoelectronic, or piezoelectric, and that the further (second) oscillation sensor, e.g., in the same way as the (first) oscillation sensor, be designed to detect mechanical oscillations of the vibrating element about a static rest position and to convert them into a sensor signal (of the measuring transducer) representing oscillations of the vibrating element—for example, namely, a velocity of oscillating movements of the vibrating element.

According to a thirty-third embodiment of the invention, it is further provided that the sensor arrangement have at least one further (second) oscillation sensor, e.g., structurally identical to the first oscillation sensor and/or electrodynamic, optoelectronic, or piezoelectric, and that the at least two oscillation sensors of the measuring transducer be structurally identical.

According to a thirty-fourth embodiment of the invention, it is further provided that the sensor arrangement have at least one further (second) oscillation sensor, e.g., structurally identical to the first oscillation sensor and/or electrodynamic, optoelectronic, or piezoelectric, and that the at least two oscillation sensors of the sensor arrangement be spaced apart from one another—for example, in such a way that they are arranged symmetrically with respect to an imaginary plane of symmetry of the at least one vibrating element.

According to a thirty-fifth embodiment of the invention, it is further provided that the sensor arrangement have at least one further (second) oscillation sensor, e.g., structurally identical to the first oscillation sensor and/or electrodynamic, optoelectronic, or piezoelectric, and that the at least two oscillation sensors of the sensor arrangement be equidistant from the at least one oscillation exciter—for example, in such a way that they are arranged symmetrically with respect to an imaginary plane of symmetry of the at least one vibrating element.

According to a thirty-sixth embodiment of the invention, it is further provided that the sensor arrangement have at least one further (second) oscillation sensor, e.g., one which is structurally identical to the first oscillation sensor and/or electrodynamic, optoelectronic, or piezoelectric, and that the sensor arrangement (apart from the first and second oscillation sensors) have no further (vibration) sensors which are designed to detect mechanical oscillations of the at least one vibrating element and to convert them into a sensor signal (of the sensor arrangement) representing oscillations of the at least one vibrating element.

According to a thirty-seventh embodiment of the invention, it is further provided that the sensor arrangement have at least one further (second) oscillation sensor, e.g., one which is structurally identical to the first oscillation sensor and/or electrodynamic, optoelectronic, or piezoelectric, and that the sensor arrangement (apart from the first and second oscillation sensors) have no further oscillation sensors which are designed to detect mechanical oscillations of the measuring transducer and to convert them into a sensor signal (of the sensor arrangement) representing oscillations of the measuring transducer.

According to a thirty-eighth embodiment of the invention, it is further provided that the sensor arrangement have at least one further (second) oscillation sensor, e.g., one which is structurally identical to the first oscillation sensor and/or electrodynamic, optoelectronic, or piezoelectric, and that the at least one oscillation exciter be positioned within at least one imaginary plane of symmetry of the at least one vibrating element.

According to a thirty-ninth embodiment of the invention, it is further provided that the sensor arrangement have at least one further (second) oscillation sensor, e.g., structurally identical to the first oscillation sensor and/or electrodynamic, optoelectronic, or piezoelectric, and that the measuring system electronics be designed to identify (digital) measurement values for at least one measurement variable also using the at least one sensor signal received during the first operating mode from the further (second) oscillation sensor, e.g., namely, a spectral (useful) signal component with a signal frequency corresponding to the useful frequency—for example, namely, to identify a volume flow and/or a mass flow of a measurement substance flowing through the measuring transducer based upon a phase difference between spectral (useful) signal components of the sensor signals of each of the two oscillation sensors (each with a signal frequency corresponding to the useful frequency).

According to a fortieth embodiment of the invention, it is further provided that the measuring system electronics have at least one (data) storage element (EEPROM) for, for example, non-volatile storage of digital (measurement and/or operating) data—for example, one or more measurement values and/or one or more (interference) parameter values and/or one or more (measuring system) parameter values. Developing this embodiment of the invention, the measuring system electronics are further designed to store (in the first operating mode) one or more (measuring system) parameter values in at least one (data) storage element, e.g., namely, to read them out (again) also in the first and/or second operating mode, and/or to store (in the second operating mode) one or more (interference) parameter values in at least one (data) storage element—for example, namely, to read them out (again) in the first and/or second operating mode. Alternatively or additionally, the measuring system electronics can also be designed to store one or more measurement values in at least one (data) storage element (EEPROM).

According to a forty-first embodiment of the invention, it is further provided that the measuring system electronics or the measuring system formed thereby be integrated into a superordinate electronic data processing system (EDP), e.g., formed by means of a programmable logic controller (PLC) and/or a process control system (PCS) and/or an edge (computing) device and/or a cloud (computing) system—for example, be connected to the superordinate electronic data processing system, viz., with respect to signal and data communication. Developing this embodiment of the invention, the measuring system electronics are further designed to communicate with the superordinate electronic data processing system via a data line and/or by radio, e.g., namely, to activate (in combination) the second operating mode and/or perform switching from the second operating mode to the first operating mode automatically and/or in dialog with a user of the measuring system.

According to a forty-second embodiment of the invention, it is further provided that the measuring system electronics have a radio unit—for example, for transmitting measuring system data (to a superordinate electronic data processing system) and/or for receiving process data (from a superordinate electronic data processing system).

According to a forty-third embodiment of the invention, it is further provided that the measuring system electronics be designed, to receive a (process status) message, e.g., generated from outside the measuring system electronics and transmitted to the measuring system electronics via data transmission and/or causing activation of the second operating mode, from a superordinate electronic data processing system (EDP) (data-linked to the measuring system electronics) and/or a display and operating element signal-linked to the measuring electronics, e.g., a display and operating element of the measuring system and/or an (on-site) operating device for the measuring system—for example, namely, to activate or execute the second operating mode based on the (process status) message. Developing this embodiment of the invention, it is further provided that the (process status) message signals that the measurement substance, e.g., with a predetermined (reference) volume and/or (reference) mass flow, be flowing through the measuring transducer, and/or that the (process status) message signal that a pump connected to the measuring transducer, e.g., via a pipe, is switched on.

According to a forty-fourth embodiment of the invention, it is further provided that the measuring system electronics be designed to activate or execute the second operating mode after the first operating mode, e.g., namely, to identify a cause of reduced functionality of the measuring system and/or to identify a cause of reduced measuring accuracy of the measuring system and/or to identify a cause of a failure of the measuring system, wherein a starting time and/or a duration Ta of the second measuring interval is such that at least the sensor signal generated and evaluated during the second measuring interval cannot or does not (still) contain any signal components attributable to a (preceding) active excitation of the useful oscillations. Developing this embodiment of the invention, it is further provided that the duration Ta of the second measuring interval be less than the duration Tnexc, e.g., in such a way that the duration Ta is not more than 95% of the duration Tnexc and/or is at least 1 s (second) shorter than the duration Tnexc (Tnexc Ta ≥1 s), and/or that the start time of the second measuring interval is set so that the second measuring interval only begins after a waiting time, e.g., of at least 1 s (second) and/or corresponding to at least 5% of the duration Tnexc, after starting the second operating mode—for example, in such a way that the waiting time corresponds to at least twice a (decay) time constant of the vibrating element, and/or is greater than 10 s.

According to a forty-fifth embodiment of the invention, it is further provided that the measuring system electronics be designed to set, in the first operating mode, a signal amplitude, determining an oscillation amplitude of the useful oscillations, of the driver signal—for example, namely, to adjust it to a (predetermined) amplitude setpoint.

According to a forty-sixth embodiment of the invention, it is further provided that the measuring system electronics be designed to identify (digital) measurement values for at least one measurement variable, in particular the viscosity and/or the density, using the driver signal (generated during the first operating mode).

According to a first further development of the invention, the measuring system also comprises an electronics housing (having several resonance frequencies), which is, for example, attached to a transducer housing of the measuring transducer and/or is metallic, for the measuring system electronics.

According to a second further development of the invention, the measuring system further comprises a transducer housing (having several resonance frequencies), which is, for example, metallic, wherein the transducer housing and the at least one vibrating element are attached to one another—for example, detachably.

A basic idea of the invention is, inter alia, to be able to detect or to detect interference oscillations (on-site) impairing the measuring accuracy and/or the functionality of vibronic measuring systems of the type in question as early as possible, e.g., during (re-)commissioning of the respective measuring system or a measuring point formed thereby, by directly identifying said interference oscillations by means of the measuring transducer of the respective measuring system, viz., while the at least one oscillation exciter or the exciter arrangement formed thereby is not supplied with power, viz., does not draw any electrical power from the connected measuring system electronics; this is in particular done in such a way that any oscillations detected by means of the at least one oscillation sensor or the sensor arrangement formed thereby cannot be or are not (actively excited) useful oscillations, but are (at most or only) passively excited oscillation movements of the measuring transducer generated by (external) interference oscillations coupled into the measuring system. This makes it possible to detect the interference oscillations relevant for the measurement accuracy and functionality as well as their actual influence on the measuring system in a very simple and cost-effective, yet very precise, manner directly on-site and, if applicable, to report them very promptly. One advantage of the invention is, inter alia, that it enables the detection of such interference oscillations without complex additional sensors or by means of conventional (standard) measuring transducers. Another advantage of the invention is, moreover, inter alia, that detection can in principle be adopted also for conventional measuring systems, not least also (standard) Coriolis mass flow measuring devices, established—for example, namely, known from the aforementioned U.S. Pat. No. 6,311,136 or also US-A 2020/0408581, or even offered by the applicant itself for Coriolis mass flow meters (http://www.endress.com/de/messgeraete-fuer-die-prozesstechnik/produktfinder?filter.business-area=flow&filter. measuring-principle-parameter=coriolis&filter.text=)—measuring transducers, and measuring system electronics, viz., implemented, if applicable, by comparatively minor modifications to the software or firmware of the respective measuring system electronics; this is also done, for example, by retrofitting or reprogramming the measuring system electronics of already installed measuring systems, if applicable on-site.

The invention as well as advantageous embodiments thereof are explained in more detail below based upon exemplary embodiments shown in the figures of the drawings. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

In the figures, in detail:

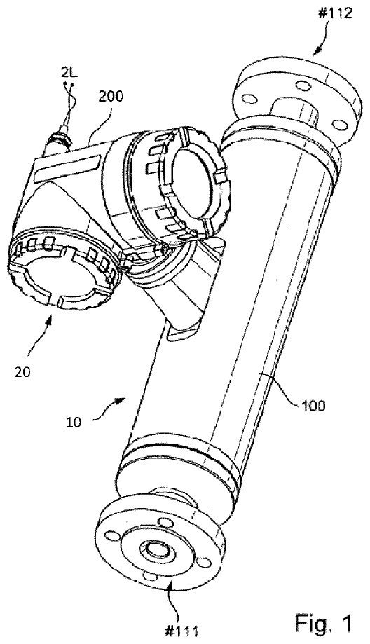

FIGS. 1, 2, 3, and 4 each show different variants or embodiments of a (vibronic) measuring system;

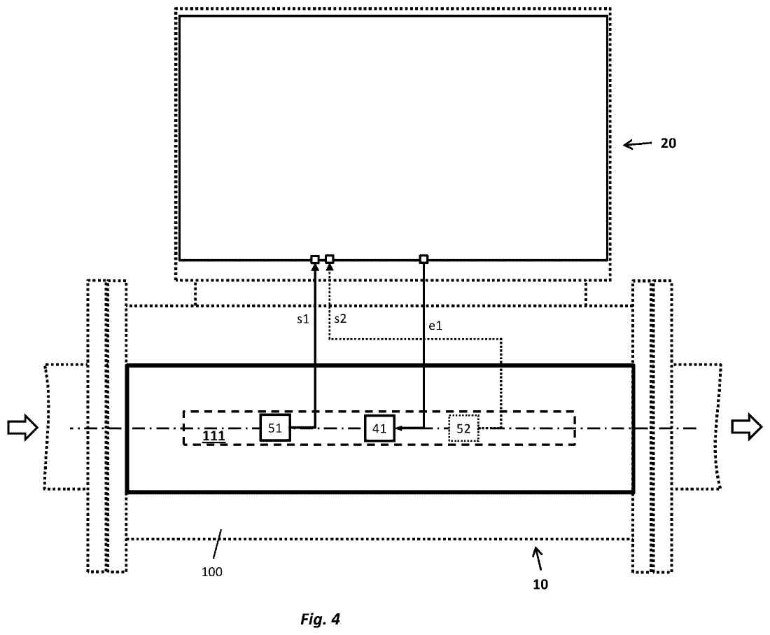

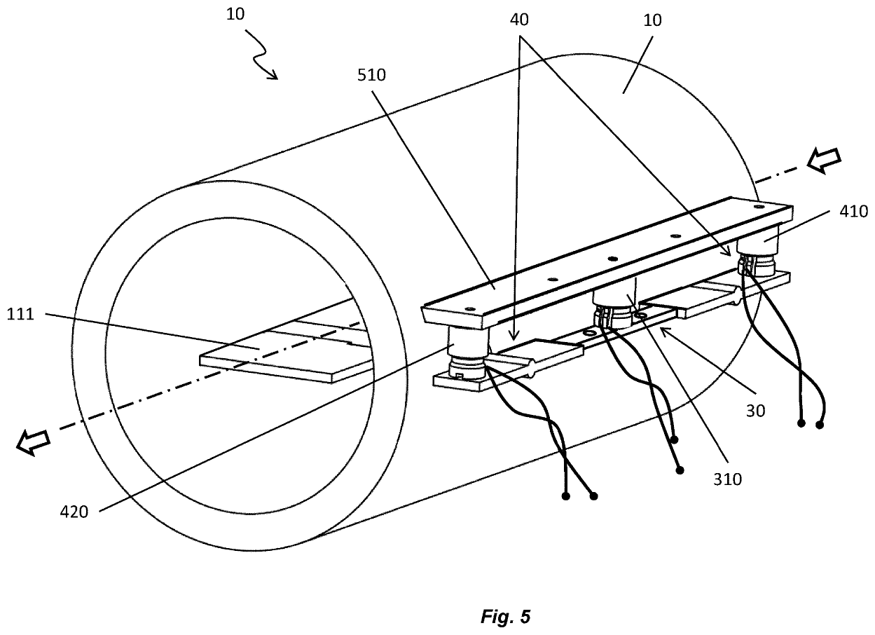

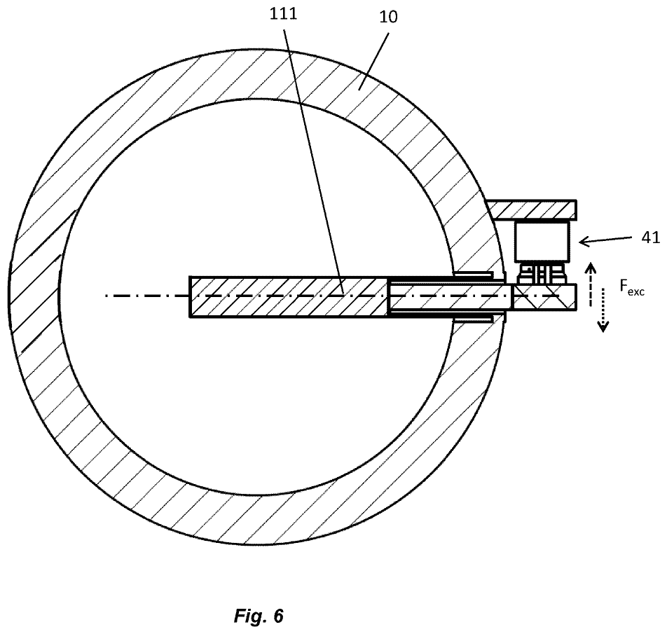

FIGS. 5 and 6 show various (partially also sectional) side views of a measuring transducer suitable for a measuring system according to FIG. 1 or 4;

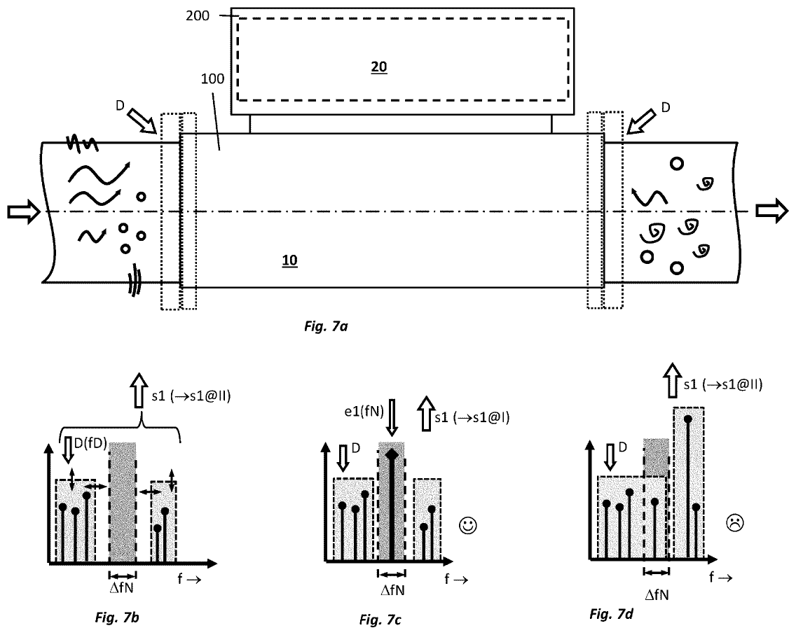

FIG. 7a shows a (vibronic) measuring system exposed to interference oscillations, in particular according to one of FIGS. 1, 2, 3, or 4; and

FIGS. 7b, 7c schematically each show an example of a respective (interference) spectrum, and 7d of interference oscillations according to FIG. 7a.

FIGS. 1, 2, 3, and 4 each show a vibronic measuring system,—which can be inserted into a pipe, in particular a pipe of an industrial (process) plant, e.g., a piping system of a chemical, pharmaceutical, biotechnological, or other process engineering process, a filling plant, or, for example, a refueling device—for flowable, in particular fluid or pourable, media, e.g., namely, also an at least temporarily 2- or multi-phase or inhomogeneous measurement substance.

The measuring system, designed, for example, as a Coriolis mass flow measuring device, Coriolis mass flow density measuring device, and/or Coriolis mass flow viscosity measuring device, serves in particular for measuring and/or monitoring a mass flow m or for identifying mass flow measurement values (X_{M}) representing the mass flow m of a (fluid) measurement substance, e.g., namely, a gas, a liquid, or a dispersion, which is conveyed in the aforementioned pipe or allowed to flow therein at least temporarily. Furthermore, the measuring system can also serve to identify a density p and/or a viscosity n and/or a Reynolds number Re of the (flowing) measurement substance. According to one embodiment of the invention, it is provided to use the measuring system for identifying mass-flow-rate measurement values of a measurement substance that is to be transferred, viz., for example, to be delivered in a specified or specifiable amount by a supplier to a customer, e.g., a liquefied gas, such as a liquid gas containing methane and/or ethane and/or propane and/or butane, or a liquefied natural gas (LNG), or also a mixture of substances formed by means of liquid hydrocarbons, viz., for example, a petroleum or a liquid fuel. The measuring system can accordingly also be designed, for example, as a component of a transfer point for freight traffic subject to calibration obligations, such as a refueling plant, and/or as a component of a transfer point, in the manner of the transfer points disclosed in the mentioned documents WO-A 02/060805, WO-A 2008/013545, WO-A 2010/099276, WO-A 2014/151829, or WO-A 2016/058745.

The measuring system comprises a physical-electrical (vibronic) measuring transducer 10 which is designed to be connected to the aforementioned pipe via an inlet end #111 and an outlet end #112 (fluidic) or to be inserted into the course of said pipe (conducting measurement substance) or for the respective measured measurement substance to flow through during operation, as well as electronic measuring system electronics 20 electrically coupled thereto—in particular, supplied with electrical energy during operation by means of internal energy storage and/or externally via a connecting cable.

Advantageously, the measuring system electronics 20, which can also be programmed and/or remotely parameterized, can further be designed such that, during operation of the measuring system, they can communicate with a superordinate electronic data processing system (EDP) (not shown here), e.g., a programmable logic controller (PLC), a personal computer, a workstation, an edge (computing) device or a cloud (computing) system, via a data transmission system, e.g., a (wired) fieldbus system, in particular, namely, can exchange measuring system data—for example, via a data line and/or (wirelessly) by radio. Measuring system data can, for example, be current measurement and/or diagnostic values and/or setting values useful for parameterizing the measuring system electronics or controlling the measuring system. Accordingly, the measuring system electronics 20 may, for example, have such connection electronics (VS; NRG), which are fed during operation by a (central) evaluation and supply unit provided in the aforementioned data processing system and remote from the measuring system. For example, the measuring system electronics 20 (or their aforementioned connecting electronics) can be designed such that they can be connected electrically to the external electronic data processing system via a two-conductor connection 2L, optionally also designed as a 4-20 mA current loop, and, via said connection, can both obtain the electric power required for operating the measuring system from the aforementioned evaluation and supply unit of the data processing system and transmit measurement values to the data processing system, e.g., by (load) modulation of a direct supply current fed by the evaluation and supply unit. Moreover, the measuring system electronics 20 may also be designed such that they can be operated nominally at a maximum electrical power of 1 W or less and/or are intrinsically safe. For storage, in particular for non-volatile storage, of digital (measurement and/or operating) data, e.g., namely, one or more digital measurement values and/or (measuring system) parameter values generated internally in the measuring system electronics, the measuring system electronics according to a further embodiment of the invention have at least one, in particular non-volatile, (data) storage element EEPROM.

The measuring transducer 10 is, as already indicated, a measuring transducer of the vibration type, viz., a measuring transducer with at least one vibrating element 111, e.g., having or formed with at least one (measuring) tube, which is designed to come into contact with the measurement substance, e.g., namely, be flowed around or through, and to vibrate while in contact, with a (vibration) exciter arrangement formed by means of at least one, in particular electrodynamic, or piezoelectric, oscillation exciter 41 and with a (vibration) sensor arrangement (51, 52) formed by means of at least one, for example electrodynamic, optoelectronic, or piezoelectric, (first) oscillation sensor 51; this is done, for example, in such a way that the at least one oscillation exciter 41 is to some extent fixed to the at least one vibrating element 111, and that the at least one oscillation sensor 51 is to some extent fixed to the vibrating element 111 or is arranged in the vicinity thereof (detecting the oscillations without contact). Not least for the aforementioned case that the measuring system is a Coriolis mass flow measuring device, the at least one oscillation exciter is positioned according to a further embodiment of the invention within at least one imaginary plane of symmetry of the at least one vibrating element and/or inside the range of a vibration amplitude of at least one natural vibration mode inherent in the at least one vibrating element.

Both the at least one oscillation exciter 41 or the exciter arrangement formed thereby and the at least one oscillation sensor 51 or the sensor arrangement formed thereby are each electrically connected to the measuring system electronics. The at least one oscillation exciter 41 or the exciter arrangement formed thereby is in particular designed to convert electrical power fed in (by the measuring system electronics 20) into forced mechanical (useful) oscillations of the at least one vibrating element 111 around a static rest position (actively) exciting mechanical power; this is done in particular in such a way that the (useful) oscillations are suitable for generating Coriolis forces in the measurement substance flowing through the measuring transducer 10 and dependent upon the mass flow thereof (forcing additional elastic deformations of the vibrating element 111), and/or that the (useful) oscillations have a (useful) frequency fN corresponding to a (current) resonance frequency of the vibrating element 111 or of the measuring transducer 10 formed thereby. According to a further embodiment of the invention, the at least one vibrating element 111 or the measuring transducer formed thereby is designed such that the useful frequency fN is more than 50 Hz and/or less than 2 kHz, in particular more than 200 Hz and less than 1,500 Hz.

In addition, the at least one oscillation sensor 51 or the sensor arrangement formed thereby is designed to detect mechanical oscillations of the at least one vibrating element 111 around the aforementioned static rest position and to convert them into a (first) sensor signal s1 (of the sensor arrangement) representing oscillations of the vibrating element 111, viz., a velocity of oscillating movements of the vibrating element 111. The at least one oscillation sensor 51 can advantageously be designed to measure a velocity (of oscillation movements of the vibrating element 111), or the at least one sensor signal s1 can advantageously be designed such that it represents a velocity of oscillation movements of the vibrating element 111. Alternatively or additionally, the at least one oscillation sensor 51 and the at least one oscillation exciter 41 can, for example, also be designed to be (effectively) functionally identical, in particular, namely, also structurally identical. According to a further embodiment of the invention, the at least one oscillation exciter 41 is an electrodynamic oscillation exciter (formed by means of a voice coil), and/or the at least one oscillation sensor 51 is an electrodynamic oscillation sensor (formed by means of a voice coil).

Not least for the aforementioned case that the measuring system is a Coriolis mass flow measuring device, the at least one oscillation sensor 51 is arranged at a distance from the oscillation exciter according to a further embodiment of the invention, e.g., namely, in the direction of a (main) flow axis of the vibrating element 111 or the measuring transducer formed thereby, and/or the sensor arrangement according to a further embodiment of the invention has at least one further (second) oscillation sensor 52, e.g., structurally identical to the first oscillation sensor 51 and/or is electrodynamic, optoelectronic, or piezoelectric, wherein the sensor arrangement (51, 52) of the measuring transducer 10 formed in this way is designed to detect mechanical oscillations of the at least one vibrating element 111 by means of both the first oscillation sensor 51 and also by means of the second oscillation sensor 52, and to provide first and second sensor signals s1, s2 (of the same signal type) representing at least to some extent the oscillation movements of the at least one vibration element 111; this in particular done in such a way that said sensor signals s1, s2 (with the vibrating element 111 performing useful oscillations) follow a change in the mass flow of the measurement substance conveyed in the measuring transducer 10 with a change in at least one phase difference Δφ12, viz., a change in at least one difference between a (first) phase angle φ1 of the sensor signal s1 (or one of its spectral signal components) and a (second) phase angle φ2 of the sensor signal s2 (or one of its spectral signal components). Furthermore, the sensor signals s1, s2 can have at least one signal frequency and/or signal amplitude dependent upon the density and/or viscosity of the measurement substance. According to a further embodiment of the invention, the (further) oscillation sensor 52 is also electrically connected to the measuring system electronics, e.g., in the same way as the oscillation sensor 51, and/or the oscillation sensor 52 (in the same way as the oscillation sensor 51) is designed to detect mechanical oscillations of the at least one vibrating element 111 about its aforementioned static rest position and to convert them into the sensor signal s2 representing oscillations of the vibrating element 111—for example, namely, a velocity of oscillating movements of the vibrating element 111. Not least in the aforementioned case that the measuring system is a Coriolis mass flow measuring device, the at least two oscillation sensors of the measuring transducer can be designed to be structurally identical and/or arranged at a distance from one another or from the oscillation exciter for example, also in such a way that they are symmetrical and/or equidistant from the at least one oscillation exciter with respect to an imaginary plane of symmetry of the at least one vibrating element. According to a further embodiment of the invention, it is further provided that the sensor arrangement (apart from the first and second oscillation sensors) not have any further (vibration) sensors which are designed to detect mechanical oscillations of the at least one vibrating element and to convert them into a sensor signal (of the sensor arrangement) representing oscillations of the at least one vibrating element, and/or it is provided that the sensor arrangement (apart from the first and second oscillation sensors) have no further oscillation sensors which are designed to detect mechanical oscillations of the measuring transducer and to convert them into a sensor signal (of the sensor arrangement) representing oscillations of the measuring transducer.

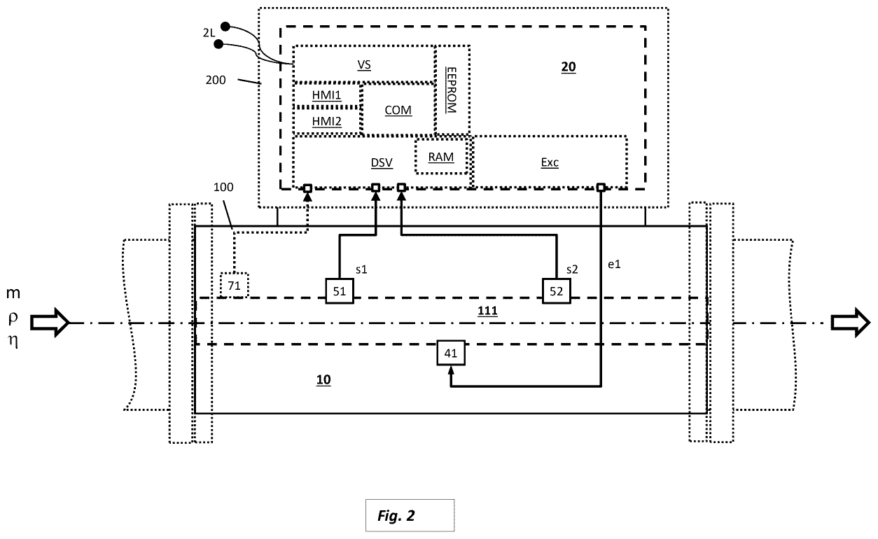

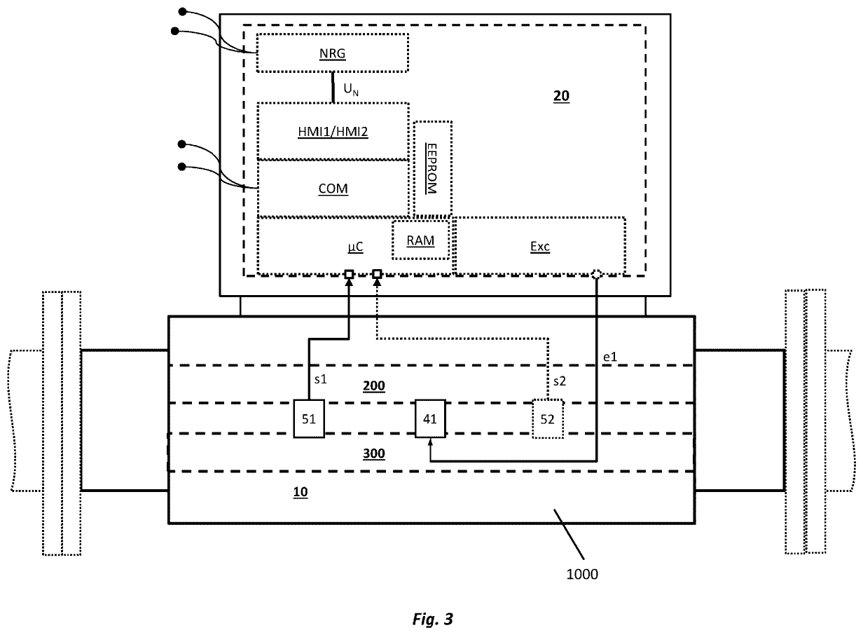

For controlling or driving the measuring transducer or its exciter arrangement, the measuring system electronics 20, as also shown schematically in FIG. 2 or 3 in the manner of a block diagram, can further have drive electronics Exc connected or electrically coupled to the exciter arrangement—for example, namely, connected to the exciter arrangement via electrical connecting lines.

In the exemplary embodiment shown in FIG. 2, the at least one vibrating element 111 has at least one (measuring) tube, e.g., one that is at least sectionally straight and/or at least sectionally curved, or the at least one vibrating element is formed by means of said (measuring) tube, wherein said (measuring) tube is designed to guide the at least temporarily flowing fluid measurement substance (or for said measurement substance to flow through) and, as already mentioned, to be allowed to vibrate at least temporarily during this. Accordingly, the measuring transducer can, for example, also a conventional measuring transducer of the vibration type from the prior art, not least also known from the aforementioned US-A 2015/0268082, US-A 2011/0271756, US-A 2010/0011882, US-A 2010/0139416, US-A 2011/0146416, US-A 2011/0265580, US-A 2016/0033314, US-A 2016/0349091, US-A 2020/0132529, US-A 2020/0408581, US-A 2021/0140804, US-A 2023/0037109, U.S. Pat. Nos. 5,602,345, 5,736,653, 5,796,011, 5,796,012, 5,804,741, 5,926,096, 6,311,136, 6,557,422, 7,325,462, 7,353,717, 9,372,107, 10,408,652, 10,598,534, 10,809,109, 11,073,416, WO-A 2017/069749, WO-A 2019/017891, WO-A 2019/040089, WO-A 2019/081169, WO-A 2019/081170, WO-A 2021/136626, WO-A 93/21505, WO-A 96/05484, or WO-A 96/08697, or a measuring transducer of a conventional Coriolis mass flow measuring device. The vibration element 111 formed by means of at least one (measuring) tube can—as also indicated in FIG. 2 and readily apparent from a comparison of FIGS. 1 and 2—together with the exciter arrangement (41) and the sensor arrangement and, if necessary, further components of the measuring transducer, be accommodated within a transducer housing 100 made, for example, of a (stainless) steel. According to a further embodiment of the invention, the aforementioned (useful) oscillations of the vibrating element formed by the at least one (measuring) tube are at least to some extent designed as bending oscillations of the at least one (measuring) tube, in particular, namely, such bending oscillations as are suitable for generating Coriolis forces (additionally deforming the measuring tube) in the measurement substance flowing through the (measuring) tube which are dependent upon the mass flow thereof. According to a further embodiment of the invention, for this purpose, the at least one oscillation exciter 41 is positioned—as also indicated in FIG. 2—for example in the center of the at least one (measuring) tube (111), and/or the oscillation exciter 41 is the only oscillation exciter of the exciter arrangement or of the measuring transducer formed thereby causing oscillations of the at least one (measuring) tube (111). In the aforementioned case where the sensor arrangement has two oscillation sensors, the first oscillation sensor 51 can also be mounted, for example, on the inlet side, and the second oscillation sensor 52 can be mounted, for example, on the outlet side of at least one (measuring) tube serving as a vibrating element—as already indicated and as is quite common in a measuring system of the type in question designed as a Coriolis mass flow measuring device; this is also done, for example, in such a way that the oscillation sensors 51, 52 are each positioned at the same distance from the center of said (measuring) tube—for example, also forming a sensor arrangement that is (mirror-)symmetrical with respect to an imaginary (mirror) plane that imaginarily intersects the (measuring) tube in its center. In addition, the two aforementioned oscillation sensors 51, 52 can for example also be the only oscillation sensors that are used to detect oscillations of the at least one measuring tube forming the vibrating element, in such a way that the sensor assembly does not have any other oscillation sensors apart from said oscillation sensors 51, 52. According to a further embodiment of the invention, it is further provided that the sensor arrangement of (vibration) sensors, each of which is designed to detect mechanical oscillations of the at least one vibrating element and to convert them into a sensor signal (of the sensor arrangement) representing oscillations of the vibrating element, in particular, namely, a velocity of oscillating movements of the vibrating element, have a total of no more than twice the number of (measuring) tubes (of the vibrating element or of the measuring transducer formed thereby). In addition to the aforementioned (oscillation) sensor arrangement, a temperature measuring arrangement 71 serving to detect temperatures within the tube arrangement and/or a strain measuring arrangement serving to detect mechanical stresses within the tube arrangement can, for example, also be provided in the measuring transducer. Alternatively or in addition, the at least one vibrating element, as also shown schematically in FIG. 3, can also be formed by means of at least one further (measuring) tube, therefore by means of at least two (measuring) tubes—for example, in such a way that the (structurally identical) at least two (measuring) tubes of the vibrating element are connected (fluidically) in parallel to one another and/or are designed for the measurement substance to simultaneously flow through them and to vibrate (opposite) during this. In this case, the (useful) oscillations of the vibrating element excited by means of the at least one oscillation exciter or identified by means of the at least one oscillation sensor can, for example, also be at least to some extent (opposite) bending oscillations of the at least two (measuring) tubes.

In a further variant of the invention, the at least one vibrating element, as also schematically illustrated in FIGS. 4, 5, or 6, can have or be formed with an, in particular plate-shaped or rod-shaped, immersion body; this, for example, is also done in such a way that the immersion body (111) is arranged at least to some extent within a lumen of a partial segment of the pipe or within a lumen of a tube of the measuring transducer inserted into the course of the pipe and is designed for the measurement substance to flow around it and to be allowed to vibrate during this. Accordingly, the measuring transducer can, for example, also be formed by means of such a vibrating element as shown in the aforementioned EP-B 564 682, U.S. Pat. Nos. 4,420,983, 5,392,656, US-A 2016/0334316, U.S. Pat. No. 11,530,967, WO-A 2015/155044, WO-A 95/33981, or U.S. Pat. No. 9,372,107, or the measuring transducer can correspond to one of the measuring transducers shown therein.

To process the one or more sensor signals s1, s2 supplied by the measuring transducer, the measuring system electronics 20 also have (digital) measurement and control electronics DSV. The measurement and control electronics DSV are, as already indicated and schematically shown in FIG. 2, electrically connected to the measuring transducer 10 or its sensor arrangement 51, 52 and are designed to receive and evaluate the at least one sensor signal s1, viz., to generate the at least one (digital) measurement value representing a measurement variable and, if applicable, also to output it—for example, in the form of digital values to the aforementioned data processing system (EDP). In addition, the measurement and control electronics DSV can be coupled electrically or by signal to the drive electronics Exc—for example, namely, via a digital bus internal to the measuring system electronics—and can also be designed to control the drive electronics Exc and/or to form a drive control loop of the measuring system electronics (which serve to generate the useful oscillations) by means of the drive electronics Exc.

For the aforementioned case that the sensor arrangement is formed by means of two oscillation sensors, and is therefore designed to provide two sensor signals s1, s2, the measurement and control electronics DSV are also designed in particular to receive and evaluate both the sensor signal s1 and the sensor signal s2—for example, namely, to identify analog and/or digital (mass flow) measurement values representing the mass flow based upon the aforementioned at least two sensor signals s1, s2. The sensor signals (s1, s2) generated by the measuring transducer 10 and fed to the measuring system electronics 20 or the measurement and control electronics DSV provided therein, e.g., via electrical connecting lines, can initially also be pre-processed there for example, pre-amplified, filtered, and digitized. Not least for the aforementioned case that the measuring system is a Coriolis mass flow measuring device, the measurement and control electronics DSV have a first measuring signal input for the sensor signal s1 and at least one second measuring signal input for the sensor signal s2, and the measurement and control electronics DSV are further designed to identify the aforementioned phase difference from said sensor signals s1, s2. In addition, the measurement and control electronics DSV can also be designed to determine each aforementioned phase angle and/or at least one signal frequency and/or one signal amplitude from at least one of the applied sensor signals s1, s2—for example, viz., to generate during operation a sequence of digital phase values representing the respective phase angle and/or a sequence of digital frequency values representing the signal frequency and/or a sequence of digital amplitude values representing the signal amplitude. According to a further embodiment of the invention, the measurement and control electronics DSV have a digital phase output and a digital amplitude output, and the measurement and control electronics DSV are further also designed to output an amplitude sequence at the amplitude output, viz., a sequence of digital amplitude values identified on the basis of at least one of the sensor signals, e.g., namely, quantifying the signal amplitude of one of the sensor signals, and a phase sequence at the phase output, viz., a sequence of digital phase values identified on the basis of the sensor signals.

The measurement and control electronics DSV can also be implemented, for example, by means of a microcomputer provided in the measuring system electronics 20—for example, implemented by means of a digital signal processor DSP, and by means of program codes implemented accordingly and running therein. The program codes can be stored persistently in the aforementioned (non-volatile) data storage EEPROM of the microcomputer, for example, and loaded into a volatile data storage RAM integrated into the microcomputer when the microcomputer is started.

As already indicated, the sensor signals s1, s2 are to be converted into corresponding digital signals (in conformity with the WKS sampling theorem) for processing in the microcomputer by means of corresponding analog-to-digital converters (A/D converters) of the measurement and control electronics DSV or the measuring system electronics 20 formed thereby; cf., in this regard, for example, U.S. Pat. No. 6,311,136 or US-A 2011/0271756 mentioned above. Accordingly, according to a further embodiment, in the measurement and control electronics DSV, a first analog-to-digital converter is provided for the first sensor signal s1, and, in the event that the sensor arrangement has the second oscillation sensor 52, a second analog-to-digital converter is provided for the aforementioned second sensor signal s2.

The measuring system electronics 20 and therefore their aforementioned drive electronics Exc and the measurement and control electronics DSV as well as other electronic components of the measuring system electronics 20 that serve to operate the measuring system, such as an internal power supply circuit VS for providing internal DC supply voltages and/or transmitting and receiving electronics COM for communicating with a superordinate measurement data processing system or an external fieldbus, can (as is also readily apparent from a combined view of FIGS. 1, 2, 3, and 4) also be housed, for example, in a corresponding in particular impact- and/or explosion-proof and/or hermetically sealed and/or metallic electronics housing 200. Said electronics housing 200 can, for example—as also shown in each of FIGS. 1, 2, 3, or 4—be mounted on the aforementioned transducer housing 100 to form a vibronic measuring system or a Coriolis mass flow measuring device in a compact design.

The electrical connection of the measuring transducer MW to the measuring system electronics 20 can be effected by means of corresponding electric connecting lines and corresponding cable feedthroughs. In this case, the connecting lines can be formed at least partially as electric conductor wires sheathed at least in some portions by electric insulation—for example, in the form of “twisted pair” lines, ribbon cables, and/or coaxial cables. As an alternative or in addition thereto, the connecting lines can also be formed at least in some portions by means of conductors of a circuit board, especially a flexible, optionally varnished circuit board. In order to visualize measurement values generated internally by the measuring system and/or, possibly, status messages generated internally by the measuring system, such as an error message or an alarm, on-site and/or to operate the measuring system on-site, the measuring system can further comprise a display element HMI1 that communicates at least intermittently with the measuring system electronics 20 and/or an operating element HMI2 that communicates at least intermittently with the measuring system electronics 20, such as an LCD, OLED, or TFT display placed in the aforementioned electronics housing 200 behind a window provided therein, as well as a corresponding input keyboard and/or a touchscreen (as a combined display and operating element). According to a further embodiment of the invention, the operating element HMI2 is designed to convert one or more manual inputs (of a user of the measuring system) into one or more control signals, e.g., also containing one or more (control) commands for the measuring system electronics 20, and to send them to the measuring system electronics 20. Accordingly, the measuring system electronics 20 can also be designed to receive and process one or more control signals from the operating element HMI2, possibly also containing one or more (control) commands—for example, to execute one or more (control) commands transmitted by means of one or more control signals. Alternatively or additionally, the measuring system electronics can also be designed to generate control signals for the aforementioned display element HMI1 and to output them to the display element HMI1. In addition, the display element HMI1 can be designed to receive and process one or more control signals from the measuring system electronics 20—for example, to display one or more messages transmitted by means of one or more control signals.

To excite the aforementioned useful oscillations of the at least one vibrating element, the measuring system electronics of the measuring system according to the invention, e.g., namely, their aforementioned drive electronics Exc together with the measurement and control electronics DSV controlling them, are in particular designed to operate in a first operating mode I (active mode) in particular lasting more than 10 ms (milliseconds) and during this to supply power to the exciter arrangement, viz., to feed electrical power into the at least one oscillation exciter or the exciter arrangement formed thereby by means of an electrical driver signal e1, e.g., having a predeterminable signal frequency corresponding to a current resonance frequency of the measuring transducer and/or a predeterminable signal amplitude, in such a manner that the at least one vibrating element, at least during a first measuring interval Texc lasting more than 10 ms, at least to some extent performs forced mechanical oscillations serving as useful oscillations with at least one useful frequency, e.g., namely, also with a predetermined (useful) amplitude, and that the at least one sensor signal (at least during the first measuring interval) at least to some extent represents the useful oscillations of the vibrating element; this is done, for example, in such a way that the at least one sensor signal contains a (useful) signal component, viz., a (spectral) signal component with a (signal) frequency corresponding to the useful frequency and with the aforementioned (first) phase angle. The driver signal e1 can, for example, be a harmonic or sinusoidal electrical (alternating) signal or, for example, a multi-frequency electrical (alternating) signal, possibly also periodic for a predeterminable duration, composed of several (spectral) signal components, but containing a spectral (useful) signal component with the signal amplitude and signal frequency.

According to a further embodiment of the invention, the measuring system electronics are further designed to provide the—for example, bipolar and/or at least temporarily periodic, possibly also harmonic-driver signal e1 with a signal frequency of not less than 50 Hz (Hertz) and/or not more than 2 kHz; this is in particular also done in such a way that the signal frequency of the driver signal e1 corresponds to a current resonance frequency fR of the measuring transducer, e.g., namely, a resonance frequency (co-determined by the density and viscosity of the measurement substance) of a natural (bending) vibration mode inherent in the at least one vibrating element 111, in particular, namely, of a fundamental (bending) vibration mode, or that the excited (useful) oscillations of the at least one vibrating element 111 are resonance oscillations (co-determined by the density and viscosity of the measurement substance). The aforementioned resonance frequency fR or the corresponding respective useful frequency fN (fN=fR) is subject to temporal changes due to temporal changes in the density or viscosity of the respective measurement substance during operation of the measuring system, in such a way that the resonance or useful frequency can assume frequency values lying within a (useful) frequency band ΔfN having a predeterminable (measuring-system-specific) lower and upper limit frequency—for example, corresponding to a predeterminable density measuring range of the measuring system. The lower limit frequency can, as already mentioned and quite common for such measuring systems, for example, be more than 50 Hz, in particular more than 200 Hz, while the upper limit frequency, as also already mentioned, can, for example, be less than 2 kHz, in particular less than 1,500 Hz. According to a further embodiment of the invention, the measuring system electronics are further designed to vary, in operating mode I, the signal frequency, determining the useful frequency fN, of the driver signal e1 within the aforementioned (useful) frequency band, in particular to adapt or adjust it to a current resonance frequency (fR) of the vibrating element 111.

Not least in order to set the signal frequency of the driver signal e1 to one of the aforementioned resonance frequencies, the measuring system electronics according to a further embodiment of the invention are also designed, inter alia, to set the signal frequency of the driver signal e1 at least in the first operating mode I using the at least one sensor signal received during the first operating mode I, e.g., namely, on the basis of a spectral (useful) signal component with a signal frequency corresponding to the useful frequency fN, or the measuring system electronics are designed to identify, using the at least one (first) sensor signal s1 (s1→s1@I) received during operating mode I, at least one (current) resonance frequency of the measuring transducer, in particular, namely, of its vibration element, or of the measuring system formed thereby—for example, namely, to identify one or more digital (measuring system) parameter values representing said resonance frequency on the basis of the sensor signal s1 (s1→s1@I). Advantageously, the measuring system electronics can also be designed (in operating mode I) to store one or more (measuring system) parameter values in the aforementioned at least one storage element EEPROM in a non-volatile manner and, if necessary, to read them out again.

For setting or measuring the useful frequency fu or the corresponding resonance frequency of the measuring transducer, the aforementioned drive electronics Exc, as is quite common in vibronic measuring systems of the type in question or Coriolis mass flow measuring devices, have for example, one or more phase-locked loops (PLL) (controlled by means of the at least one sensor signal). According to a further embodiment of the invention, the drive electronics Exc have a digital frequency output. In addition, the drive electronics Exc are also designed to output at said frequency output a frequency sequence, specifically a sequence of digital frequency values that quantify the signal frequency set for the driver signal e1—for example, specifically the currently set useful frequency (or the signal frequency of its signal component E1). According to a further embodiment of the invention, it is further provided that the aforementioned phase output of the measurement and control electronics DSV be electrically connected to a phase input formed, for example, by means of a phase comparator provided within the drive electronics Exc. Said phase comparator can, for example, also be designed to identify a phase difference between the aforementioned signal component E1 of the driver signal e1 and at least one of the aforementioned useful components S1*, S2*, and/or to determine an extent of said phase difference. In addition, the amplitude output of the measurement and control electronics DSV can also be correspondingly electrically connected to an amplitude input of the drive electronics Exc which detects the amplitude of the signal component or the oscillations of the at least one vibration element excited thereby.

The measuring system electronics of the measuring system according to the invention, e.g., namely, the aforementioned measurement and control electronics DSV, are furthermore also designed to receive and correspondingly evaluate the at least one sensor signal s1 (s1Δs1@I) or the sensor signals s1, s2 (s1Δs1@I, s2Δs2@I) during the first operating mode I, in particular, namely, during the first measuring interval, in particular, namely, using the at least one sensor signal s1 received during the operating mode I, or using the at least two sensor signals s1, s2 received during the operating mode I, e.g., namely, by means of the respective aforementioned spectral (useful) signal component described above, to determine the measurement values for at least one measurement variable. Advantageously, the measuring system electronics can also be designed to store (in a non-volatile manner) one or more measurement values in the aforementioned at least one EEPROM (data) storage element—for example, also together with (additional) data specifying the time and/or location of the determination of the measurement values.

According to a forty-fifth embodiment of the invention, it is further provided that the measuring system electronics be designed to set, in the first operating mode, a signal amplitude, determining an oscillation amplitude of the useful oscillations, of the driver signal—for example, namely, to adjust it to a (predetermined) amplitude setpoint.

According to a forty-sixth embodiment of the invention, it is further provided that the measuring system electronics be designed to identify (digital) measurement values for at least one measurement variable, in particular the viscosity and/or the density, using the driver signal (generated during the first operating mode).

Not least for the aforementioned case that the measuring system is designed as a Coriolis mass flow measuring device and the sensor arrangement is formed by means of two oscillation sensors spaced apart from each other, the useful oscillations excited in this way during the first operating mode are, as already indicated, in particular designed in such a way that the at least one vibrating element causes additional (elastically) deforming Coriolis forces in the measurement substance flowing through the measuring transducer, and that each of the sensor signals s1, s2 contains a (spectral) signal component sN1 or sN2 serving as a (useful) signal component with a signal frequency corresponding to the useful frequency and with a respective (first or second) phase angle, or that, between the two (useful) signal components sN1, sN2, a corresponding phase difference Δφ12 (Δφ12′=φ1−φ2=f (m)) (dependent upon the mass flow m of the measurement substance flowing through the measuring transducer) exists. Accordingly, the measuring system electronics can advantageously also be designed, in particular, to measure a volume flow and/or a mass flow of a measurement substance flowing through the measuring transducer or to identify measurement values representing the volume flow and/or the mass flow based upon said phase difference, if applicable also taking into account the current useful frequency. According to a further embodiment of the invention, the measurement and control electronics DSV are furthermore designed, based upon the sensor signals s1, s2 received during one or more first measuring intervals, to first identify one or more, in particular digital, (first) phase difference measurement values X_{Δφ1}, each of which represents the first phase difference Δφ12 (of the sensor signals s1, s2 received during one or more first measuring intervals)—for example, in order to identify one or more of the aforementioned mass-flow-rate measurement values XM using one or more (first) phase difference measurement values X_{Δφ1}. Alternatively or in addition, the measurement and control electronics can be further designed to determine, based upon sensor signals s1 received during one or more first measuring intervals, one or more in particular digital (first) phase angle measurement values X_{φ1} representing the first phase angle φ1 (of the sensor signal s1 received during one or more first measuring intervals) and/or to determine, based upon sensor signals s2 received during one or more first measuring intervals, one or more in particular digital (second) phase angle measurement values X_{φ2} representing the second phase angle φ2 (of the sensor signal s2 received during one or more first measuring intervals). The aforementioned phase angles φ1, φ2 or phase angle measurements X_{φ1}, X_{φ2} can be determined, e.g., in reference to the electrical driver signal e1 or also to an internal (clock) reference signal of the measuring system electronics 20, in particular that is generated by means of the measurement and control electronics DSV or the drive electronics Exc, with a clock frequency corresponding to the useful frequency—for example, as a phase difference from the driver signal e1 or from its useful signal component E1 and/or from the aforementioned (clock) reference signal.

Advantageously, the operating mode I and the first measuring interval can also be selected, for example, such that the first useful oscillations performed during this, in particular with regard to their useful frequency and/or their useful amplitude, are as stationary as possible or stable as possible, and/or that both the operating mode I as well as the first measuring interval each have a duration which corresponds to more than a reciprocal value (1/f_{N}) of the useful frequency f_{N} or last longer than 1 s (second), in particular longer than 1 min (minute) or, for example, longer than 1 h (hour).

As already mentioned, vibronic measuring systems of the type in question can exhibit cross-sensitivities, inter alia, also to externally excited mechanical interference oscillations D (FIG. 7a), viz., those not generated by the respective exciter arrangement or merely from outside the measuring system—for example, sound waves propagating through the connected pipe (structure-borne sound) and/or oscillations of the connected pipe, etc., coupled into the measuring transducer in the form of turbulences or pressure fluctuations (in the measurement substance)—in such a way that the measuring accuracy of the measuring system or the functionality of the measuring system as a whole is at least temporarily impaired; this applies in particular in the case that one or more of the interference oscillations assume such (interference) frequencies fD as correspond to or are similar to the current or indicated useful frequency fN, viz., have only a negligibly small frequency difference from the useful frequency fN, or are located within the aforementioned (useful) frequency band ΔfN, and/or in the event that one or more of the interference oscillations with an (interference) frequency similar to said useful frequency fN have an (interference) amplitude comparable to the current (useful) amplitude of the useful oscillations, or have an overall (spectral) power density that is too high. However, undesirable oscillations of the measuring transducer or of the measuring system formed thereby that can be excited or are excited by the aforementioned interference oscillations can also be oscillations generated from outside the measuring system, for example, whose respective oscillation frequency corresponds to a (mechanical) resonance frequency of the aforementioned transducer housing 100 and/or the aforementioned electronics housing 200. The aforementioned interference sources causing interference oscillations D can, for example, be system components mechanically coupled to the respective measuring transducer via a pipe and causing (line) vibrations, such as pumps and/or valves, or, for example, turbulences and/or inhomogeneities in the flowing measurement substance.

Not least for the purpose of reducing or avoiding impairments of the measuring system associated with the aforementioned interference oscillations, in particular also a reduction in its measuring accuracy, the measuring system electronics of the measuring system according to the invention are furthermore in particular also designed, in a second operating mode II, to not supply power the exciter arrangement for a set duration Tnexc, in particular not less than 1 s (second) and/or not more than 15 min (minute), for example, which, namely, can also be adjusted; this is done in particular also in such a way that the at least one vibrating element, at least during a second measuring interval (within the operating mode II), during which the measuring system electronics operating in operating mode II receive and evaluate at least one sensor signal s1 or the sensor signals s1, s2, does not perform any useful oscillations (excited by the exciter arrangement), or that at least during the second measuring interval, useful oscillations (possibly previously excited by means of the exciter arrangement) of the vibrating element 111 have decayed. In this way, it can be ensured very easily that, during operating mode Il or at least during the second measuring interval, any oscillations of the at least one vibrating element 111 that may nevertheless occur are only oscillations that are passive or excited from outside the measuring transducer, and therefore may be or are only the aforementioned undesired interference oscillations. Accordingly, the at least one sensor signal s1 (s1→s1@II)—as also schematically shown in FIG. 7b—excited during operating mode II (or during the second measuring interval), represents at most the aforementioned (interference) oscillations of the at least one vibrating element 111 (although not useful oscillations)—which are only passive or only excited from outside the measuring transducer 10, in such a way that one or more signal parameters, e.g., namely, one or more signal frequencies and/or one or more (spectral) signal amplitudes, represent one or more interference parameters, e.g., namely, one or more of the aforementioned (interference) frequencies and/or (interference) amplitudes, or, namely, correspond to said interference parameters.

Accordingly, the at least one sensor signal s1 (s1→s1@II) recorded in the aforementioned duration, viz., during operating mode Il or the second measurement interval, contains frequency information relevant to the measurement accuracy or functionality of the measuring system, or a corresponding (spectroscopic) fingerprint of the measuring system or the measuring point formed thereby.

Assuming that at least one sensor signal s1 (s1→s1@II) substantially only can contain or contains the frequency information relevant for identifying the external interference influences—serving as a (spectroscopic) fingerprint—but does not represent any actively excited (useful) oscillations of the at least one vibrating element 111, the measuring system electronics 10 of the measuring system according to the invention are accordingly also designed to use the at least one sensor signal s1 (s1→s1@II) received during the operating mode II (passive mode) or during the aforementioned second measuring interval to identify one or more (digital) (interference) parameter values for the at least one interference parameter (of the measuring system or the measuring point formed thereby)—which may also influence the functionality or the measuring accuracy of the measuring system—in particular to identify an (interference) frequency spectrum of (externally excited) interference oscillations of the measuring system or a measuring point formed thereby—which serves as a (spectroscopic) fingerprint, and/or to calculate one or more measurement values for at least one measurement variable using the at least one sensor signal received during the aforementioned second measuring interval or one or more (interference) parameter values obtained therefrom. Advantageously, the measuring system electronics 20 can also be designed to store one or more (interference) parameter values in the aforementioned at least one storage element EEPROM in a non-volatile manner, e.g., already during operating mode II and/or also together with (additional) data specifying the time and/or location of the determination of the (interference) parameter values. Furthermore, the measuring system electronics 20 can advantageously also be designed to (again) read out one or more of the (interference) parameter values stored (in a non-volatile manner) in the storage element EEPROM in operating mode I and/or in operating mode II—for example, for the purpose of a mutual comparison of (interference) frequency spectra or fingerprints determined for different time intervals.

In order to be able to ensure that, by using the sensor signal s1 (s1→s1@II) generated during operating mode II, as many (spectral) signal components as possible of the interference oscillations relevant for a qualification of the measuring system or the measuring point formed thereby can be determined, the duration Tnexc is selected or set to be greater than 2 s, in particular, namely, not less than 5 s, according to a further embodiment of the invention.

The operating mode Il can, for example, be executed directly from operating mode I by the measuring system electronics or its drive electronics switching off the previously provided driver signal e1 and also leaving it switched off for at least the previously specified duration Tnexc.

According to a further embodiment of the invention, the measuring system electronics are accordingly also designed to activate or execute operating mode II after operating mode I, e.g., to identify as quickly as possible a cause of a (since determined) reduced functionality of the measuring system, and/or to determine as quickly as possible a cause of a (since determined) reduced measurement accuracy of the measuring system, and/or to determine as quickly as possible a cause of a failure of the measuring system, e.g., from a loss of at least one sensor signal s1; this is done, for example, also in such a way that the measuring system electronics are operated alternatingly, e.g., also cyclically intermittently, in operating mode I or operating mode II—for example, for the purpose of improving the detection of only occasional or temporarily occurring interference oscillations. Alternatively or in addition, the measuring system electronics can also be designed, for example, to activate or execute operating mode II prior to operating mode I—for example, namely, for the (passive) calibration of the measuring point formed by means of the measuring system (involving the at least one vibrating element or the measuring transducer formed thereby) or during (re-)commissioning of the measuring system or the measuring point formed thereby. For this purpose, the aforementioned duration Tnexc can advantageously be selected to be as small as possible, e.g., namely, (set to) less than 60 s, in particular not greater than 30 s, not least for the purpose of optimizing the (commissioning) time budget to be estimated for the commissioning of the measuring system or the measuring point formed thereby. If applicable, the duration Tnexc can, however, also be readily selected or set to be greater than 1 minute, in particular greater than 10 minutes, e.g., in connection with the initial commissioning of the measuring system or the measuring point formed thereby, Not least in the case of an activation, e.g., also repeated, of the operating mode II from the (activated) operating mode I, when setting the duration Tnexc to be used for the operating mode II, a (decay) time constant naturally inherent in at least one vibrating element must also be taken into account, which time constant is dependent upon a (modal) quality factor Q1 of the vibrating element at the (last excited) useful frequency fN—and, in measuring systems of the type in question, is typically more than 5,000—for example, not less than 10,000. For 2- or multi-phase measurement substances and/or measurement substances with high viscosity, the quality factor Q1 can, for example, also be less than 100. The aforementioned (decay) time constant of the at least one vibrating element corresponds to a ratio Q1/fN of the quality factor Q1 relative to the (last excited) useful frequency f1, or can be determined in advance for the at least one vibrating element experimentally and/or numerically (based upon the aforementioned ratio Q1/fN). Not least, in order to be able to ensure that, when operating mode Il is activated from operating mode I, at least one sensor signal s1 (s1→s1@II) generated during operating mode II (no longer) contains, to the extent possible, any signal components attributable to the (previous) active excitation of the useful oscillations, the duration Tnexc according to another embodiment of the invention, at least for the case that the operating mode II is executed after the operating mode I, is correspondingly (selected) to be longer than the aforementioned (decay) time constant (of the at least one vibrating element), advantageously for example such that the duration Tnexc is more than 3 times said (decay) time constant (Q1/fN), in particular also more than 5 times the (decay) time constant, and/or is longer than 20 s, in particular also longer than 50 s, if applicable, viz., also longer than 1 min (minute).

According to a further embodiment, a duration Ta of the second measuring interval and/or a starting time of the second measuring interval is also set such that at least the sensor signal s1 generated and evaluated during the second measuring interval (s1→s1@Ta) cannot (any longer) contain or does not contain any signal components attributable to a (previous) active excitation of the useful oscillations. Accordingly, the duration Ta of the second measuring interval can, for example, also be smaller than the duration Tnexc, in particular such that the duration Ta is not more than 95% of the duration Tnexc and/or is at least 1 s (second) shorter than the duration Tnexc (Tnexc−Ta≥1 s). Alternatively or in addition, the start time of the second measuring interval can also be set such that the second measuring interval begins at the earliest after a predetermined waiting time, e.g., at least 1 s (second) and/or corresponding to at least 5% of the duration Tnexc, after starting operating mode II—for example, in such a way that the waiting time corresponds to at least twice the (decay) time constant (Q1/fN), and/or is greater than 10 s.

As already indicated, the at least one interference parameter can represent, for example, an (externally excited), in particular via a pipe and/or via a fluid conveyed in the pipe, (fluid-)mechanical interference oscillation (D) coupled into the measuring system—for example, in such a way that one or more (interference) parameter values quantify one or more (interference) amplitudes of an (interference) oscillation. Alternatively or in addition, one or more (interference) parameter values can, for example, also quantify one or more (interference) frequencies of an (interference) oscillation and/or one or more (interference) power density spectra of one or more superimposed (interference) oscillations.

According to a further embodiment of the invention, the measuring system electronics are accordingly further designed to use the at least one sensor signal s1 (s1→s1@II) received during operating mode II or one or more (interference) parameter values obtained therefrom to determine an (interference) frequency spectrum of (externally excited) interference oscillations of the measuring system or of a measuring point formed thereby (involving at least one vibrating element or the measuring transducer formed thereby). Alternatively or additionally, the measuring system electronics can also be designed to use the at least one sensor signal s1 (s1→s1@II) received during operating mode II or one or more (interference) parameter values obtained therefrom, viz., to determine a usable frequency range (of the measuring system or a measuring point formed thereby) which contain detectable or detected interference oscillations, e.g., also in such a way that an upper range limit of the usable frequency range and/or a lower range limit of the usable frequency range are determined using one or more of the (interference) parameter values, and/or to check whether—as also schematically shown in FIG. 7c—one or more (nominal) mechanical resonance frequencies of the measuring transducer or of the measuring system formed thereby lie within the aforementioned usable frequency range, in particular, namely, if applicable, to output an (enable) message ( [symbol] ) signaling this and/or enabling the first operating mode I, and/or to automatically switch to operating mode I.

According to a further embodiment of the invention, the measuring system electronics are further designed to use the at least one sensor signal s1 (s1→s1@II) received during operating mode II or one or more (interference) parameter values obtained therefrom, to determine at least one (risk) frequency range (of the measuring system or a measuring point formed thereby) containing an (interference) frequency of one or more interference oscillations, and/or to check whether, as also shown schematically in FIG. 7d, one or more (nominal) mechanical resonance frequencies of the measuring transducer or of the measuring system formed thereby lie within the aforementioned (risk) frequency range; this is also done, for example, in such a way that the measuring system electronics are designed to determine (in operating mode II) whether the aforementioned (useful) frequency band and the (risk) frequency range at least partially coincide, and/or in such a way that, in the event that one or more of the mechanical resonance frequencies (of the measuring transducer or the measuring system) lie within the (risk) frequency range, and/or in the event that the (useful) frequency band and the (risk) frequency range at least partially coincide ( [symbol] ), the measuring system electronics output a (warning) message correspondingly signaling this, and/or an (error) report identifying one or more (disturbance) sources (causing disturbance vibrations), and/or block operating mode I (at least temporarily) or deactivate the measuring system (at least temporarily). An upper range limit of the (risk) frequency range and/or a lower range limit of the (risk) frequency range can be determined, for example, based upon one or more of the (interference) parameter values—for example, by using a lowest determined (interference) frequency as the lower range limit and/or a highest determined (interference) frequency as the upper range limit.

The aforementioned (interference) frequency range or the aforementioned usable frequency range can, for example, also be determined using (interference) parameter values and/or (measuring system) parameter values stored in the interim in at least one (data) storage element EEPROM. Alternatively or in addition, (interference) parameter values and/or (measuring system) parameter values stored in the interim in at least one (data) storage element EEPROM can also be taken into account when determining measurement values representing the at least one measurement variable. According to another embodiment of the invention, the measuring system electronics are accordingly further designed to use measurement data collected during operating mode II, in particular, namely, one or more of the (interference) parameter values, e.g., also already stored (non-volatilely) in the aforementioned (data) storage element EEPROM, during operating mode I, e.g., to identify one or more of the measurement values representing the at least one measurement variable and/or to (ad hoc) check the functionality and/or measurement accuracy of the measuring system (during operating mode I or normal measuring operation); this is done in particular in such a way that the measuring system electronics in operating mode I check, using one or more interference parameter values (previously determined in operating mode II or stored non-volatilely), e.g., namely, by comparing one or more (interference) parameter values with one or more (measuring system) parameter values, whether the at least one signal frequency of the driver signal e1 or the (intended) useful frequency fN of the useful oscillations of the at least one vibrating element lies within the aforementioned (risk) frequency range (of the measuring system or a measuring point formed thereby), or whether the at least one (current) resonance frequency (of the at least one vibrating element or the measuring transducer formed thereby) lies within said (risk) frequency range. Advantageously, the measuring system electronics can also be designed, in the event ( [symbol] ) that one of the aforementioned (signal, useful or resonance) frequencies of the measuring system lies within the (interference) frequency range, to output a (warning) message signaling this and/or an (error) report identifying one or more interference sources (causing interference oscillations), and/or to deactivate the measuring system (at least temporarily) or to deactivate operating mode I.

Not least for the purpose of determining the aforementioned (interference) frequency range or estimating its effects upon the functionality or measurement accuracy of the measuring system, the measuring system electronics are further designed according to a further embodiment of the invention to determine, at least on the basis of the at least one sensor signal s1 (s1→s1@II) received during operating mode II, to perform a modal analysis for a measuring point involving the at least one vibrating element or the measuring transducer formed thereby, and/or subjecting at least said sensor signal s1 (s1→s1@II) to a spectral analysis, e.g., a Fourier analysis—for example, also based upon a (fast) discrete Fourier transform (DFT). Alternatively or in addition to determining and, if applicable, reporting the aforementioned (interference) frequency range, the measuring system electronics can advantageously also be designed, using the at least one sensor signal s1 (s1→s1@II) received during operating mode II or one or more (interference) parameter values obtained therefrom, to set a (signal) filter (of the measuring system electronics), e.g., namely, an adaptive and/or digital (signal) filter, in particular, namely, to adapt to an (interference) frequency spectrum of (externally excited) interference oscillations of the measuring system or a measuring point formed thereby, in such a way that the filter is (afterwards) designed to suppress or block (interference) signal components contained in at least one sensor signal s1 (s1→s1@II) and resulting from one or more of the interference oscillations. Advantageously, the measuring system electronics can also be designed to apply said (signal) filter to the sensor signal s1 (s1→s1@I) received during operating mode I, or to filter the at least one sensor signal s1 (s1→s1@I) received during operating mode I by means of the filter—for example, (interference) signal components contained in said sensor signal s1 (s1→s1@I). A filtered sensor signal supplied by means of the (signal) filter can, for example, be used to identify one or more measurement values for the at least one measurement variable, if necessary, for example, also together with the sensor signal s1 (s1→s1@I) initially applied to the (signal) filter.

As already mentioned, the operating mode I and/or operating mode II can be activated automatically, viz., by the measuring system electronics itself—for example, namely, time- and/or event-controlled. An event activating operating mode II can, for example, correspond to an insufficient signal quality of the at least one sensor signal s1 (s1 →s1@I) received by the measuring system electronics during operating mode I, e.g., as a result of a (process) interference, or the aforementioned loss of said sensor signal s1 (s1→s1@I)—for example, as a result of a (process-related) insufficient or non-existent useful amplitude of the useful oscillations of the at least one vibration element. Alternatively or in addition, the activation of operating mode I and/or operating mode II can, however, also be caused or triggered from outside the measuring system and/or by manual input, e.g., in conjunction with the aforementioned data processing system EDV and/or in dialog with a user of the measuring system, e.g., to perform the aforementioned (passive) calibration of the measuring system or the measuring point formed thereby in operating mode II, in particular in the course of their planned (re)commissioning and/or in the course of an (ad hoc) decommissioning of the measuring system.

According to a further embodiment of the invention, the measuring system electronics are also designed to receive and evaluate a (process status) message, e.g., generated from outside the measuring system electronics and transmitted to the measuring system electronics via data transmission, and/or generated by a (local) operating element or (local) operating device signal-linked to the measuring system electronics, in particular, namely, to activate or execute operating mode II based on the (process status) message. The operating element used to transmit the (process status) message to the measuring system electronics can, for example, be the aforementioned operating element HMI2 or the aforementioned display and operating element. The aforementioned (process state) message can advantageously be designed in such a way that it further improves the information content of the subsequently determined (interference) parameter values or the quality of the measurement data collected for determining the aforementioned (spectroscopic) fingerprint by means of the measuring system electronics during its operating mode II, e.g., in that one or more of the (interference) parameter values can also be assigned according to time and/or location to a process status of the (process) system formed by means of the measuring system or involving said measuring point, or to at least one (process) parameter characterizing the process status. For this purpose, the (process status) message is further designed according to a further embodiment of the invention such that it signals the operation of a (switched-on) pump connected (via a pipe) to the measuring transducer. Alternatively or in addition, the (process status) message can, for example, also signal that measurement substance is flowing through the measuring transducer, in particular at a specified (reference) volume and/or (reference) mass flow.

1-40. (canceled)

41. A vibronic measuring system configured as a mass flow measuring device and/or as a density measuring device and/or as a viscosity measuring device for measuring at least one measurement variable, including a density, a viscosity, a mass flow, and/or a volume flow, of a fluid measurement substance, including a gas, a liquid, or a dispersion, conveyed in a pipe connected thereto, the measuring system comprising:
a vibronic measuring transducer including:
at least one vibrating element including at least one measuring tube or formed thereby,
an exciter arrangement including at least one oscillation exciter, which is electrodynamic, optoelectronic, or piezoelectric exciter, and
a sensor arrangement including at least one oscillation sensor, which is electrodynamic, optoelectronic, or piezoelectric sensor; and
measuring system electronics electrically connected to the measuring transducer, including both to the exciter arrangement and to the sensor arrangement,
wherein the measuring transducer is configured to be fluidically connected to the pipe or inserted into a course of the pipe,
wherein the at least one vibrating element is adapted to contact the measurement substance as to be flowed around or through the at least one vibrating element and to vibrate while in contact with the measurement substance;
wherein the at least one vibration exciter, or the exciter arrangement formed therewith, is configured to convert supplied electrical power into mechanical power that excites forced mechanical useful vibrations of the at least one vibration element about a static rest position, wherein the at least one oscillation sensor, or the sensor arrangement formed thereby, is configured to detect mechanical oscillations of the at least one vibrating element about a static rest position and to convert the oscillations into a first sensor signal representing oscillations of the at least one vibrating element, including a velocity of oscillating movements of the at least one vibrating element;
wherein the measuring system electronics are configured to, in a first operating mode:
supply power to the exciter arrangement, including to feed an electrical driver signal, having a signal frequency that is predeterminable and/or corresponds to a current resonance frequency of the measuring transducer and/or having a predeterminable signal amplitude, into the at least one oscillation exciter such that the at least one vibrating element, at least during a first measuring interval, performs useful oscillations at least partially, which are forced mechanical oscillations with a useful frequency corresponding to the current resonance frequency of the measuring transducer and/or not less than 50 Hz and/or not more than 2 kHz, and such that the first sensor signal at least partially represents the useful oscillations of the at least one vibrating element; and
receive and evaluate the first sensor signal,
wherein the measuring system electronics are configured, in a second operating mode:
to not supply power to the exciter arrangement for a set, adaptable, and/or not less than 1 second(s) first duration, including such that the at least one vibrating element does not perform any useful oscillations excited by the exciter arrangement at least during a second measuring interval and/or such that useful oscillations of the at least one vibrating element previously excited by the exciter arrangement have decayed at least during the second measuring interval; and
to receive and evaluate at least one second sensor signal, which represents oscillations of the at least one vibrating element excited only passively or only external from the measuring transducer, and
wherein the measuring system electronics are configured:
to determine measurement values for the at least one measurement variable using the first sensor signal received in the first operating mode, including a spectral signal component with a signal frequency corresponding to the useful frequency; and
using the at least one second sensor signal received in the second operating mode, to determine interference parameter values for at least one interference parameter of the measuring system, or of a measuring point formed thereby, which at least one interference parameter influences the functionality and/or measurement accuracy of the measuring system and includes an interference frequency and/or an interference amplitude,
wherein the measuring system electronics are configured to determine an interference frequency spectrum of externally excited interference oscillations of the measuring system, or the measuring point formed thereby, and/or to calculate the measurement values for at least one measurement variable using the interference parameter values of the at least one interference parameter.

42. The measuring system according to claim 41, wherein at least one of:
the at least one interference parameter represents an externally excited mechanical interference oscillation coupled into the measuring system via a pipe and/or via a fluid conveyed in the pipe, wherein the at least one interference parameter is a frequency of the interference oscillation and/or an amplitude of the interference oscillation;
the interference parameter values quantify one or more interference amplitudes of the externally excited mechanical interference oscillations coupled into the measuring system via a pipe and/or via a fluid conveyed in the pipe; and
the interference parameter values quantify one or more interference frequencies of the externally excited mechanical interference oscillations that are coupled into the measuring system via a pipe and/or via a fluid conveyed in the pipe and/or that are generated by a fluid flowing through the measuring transducer.

43. The measuring system according to claim 41, wherein the first duration is greater than 2 s.

44. The measuring system according to claim 41, wherein the measuring system electronics are configured to activate or execute the second operating mode, after the first operating mode, so as to identify a cause of reduced functionality of the measuring system and/or to identify a cause of reduced measurement accuracy of the measuring system and/or to identify a cause of a failure of the measuring system.

45. The measuring system according to claim 41, wherein the at least one vibrating element has a decay time constant that is dependent upon a modal quality factor of more than 5,000 of the at least one vibrating element at the last-excited useful frequency, which corresponds to a ratio of the quality factor relative to the last-excited useful frequency.

46. The measuring system according to claim 45, wherein the first duration is greater than the decay time constant of the at least one vibrating element.

47. The measuring system according to claim 45, wherein at least one of:
the quality factor of the at least one vibrating element is not less than 10,000;
the first duration is greater than 5 times the decay time constant and/or greater than 50 s; and
the useful frequency is more than 50 Hz and/or less than 2 kHz.

48. The measuring system according to claim 45, wherein a second duration of the second measuring interval is such that at least the at least second sensor signal generated and evaluated during the second measuring interval cannot contain or does not contain any signal components attributable to a previous active excitation of the useful oscillations, and/or
wherein a starting time of the second measuring interval is such that at least the at least second sensor signal generated and evaluated during the second measuring interval cannot contain or does not contain any signal components attributable to the previous active excitation of the useful oscillations.

49. The measuring system according to claim 48, wherein the second duration is less than the first duration such that the second duration is not more than 95% of the first duration and/or is at least 1 s shorter than the first duration, and/or
wherein the start time of the second measuring interval is set such that the second measuring interval begins only after a waiting time, which waiting time is of at least 1 s and/or of at least 5% of the first duration, after starting the second operating mode such that the waiting time corresponds to at least twice the decay time constant and/or is greater than 10 s.

50. The measuring system according to claim 45, wherein the measuring system electronics are configured to activate or execute the second operating mode prior to the first operating mode for a passive calibration of the measuring point formed by the measuring system and/or during a (re-)commissioning of the measuring system, and/or
wherein the measuring system electronics are configured to use measurement data collected during the second operating mode in the first operating mode to identify one or more of the measurement values, and/or to check the functionality of the measuring system, and/or to check the measurement accuracy of the measuring system, wherein the measurement data includes the interference parameter values.

51. The measuring system according claim 50, wherein the first duration is less than 60 s.

52. The measuring system according to claim 45, wherein the measuring system electronics are configured, in the first operating mode, to provide the driver signal with the predetermined signal frequency, wherein the signal frequency is an adjustable and/or corresponds to a mechanical resonance frequency of the at least one vibrating element, or the measuring transducer formed thereby, and/or serves to set the useful frequency.

53. The measuring system according to claim 52, wherein the measuring system electronics are configured to set the signal frequency of the driver signal in the first operating mode using the at least one first sensor signal received during the first operating mode based on the spectral signal component with a signal frequency corresponding to the useful frequency, and/or
wherein the measuring system electronics are configured to check, in the first operating mode using the interference parameter values, whether the signal frequency of the driver signal or the useful frequency of the useful oscillations of the at least one vibrating element lie within a risk frequency range containing interference frequencies of one or more interference oscillations and, when applicable, to output a warning message signaling this and/or an error report indicating one or more interference sources causing the interference oscillations and/or to deactivate the measuring system at least temporarily.

54. The measuring system according to claim 41, wherein the measuring system electronics are configured to identify at least one resonance frequency of the measuring transducer, or of the measuring system formed thereby, using the first sensor signal received in the first operating mode to identify measuring system parameter values representing the at least one resonance frequency and/or to check, using the at least one second sensor signal received in the second operating mode, or the interference parameter values obtained therefrom, whether the at least one resonance frequency lies within a risk frequency range of the measuring system, or a measuring point formed thereby, containing interference frequencies of one or more of the interference oscillations.

55. The measuring system according to claim 41, wherein the measuring system electronics are configured to identify the interference frequency spectrum using the at least one second sensor signal received in the second operating mode or one or more interference parameter value obtained therefrom.

56. The measuring system according to claim 41, wherein the measuring system electronics are configured to identify, using the at least one second sensor signal received in the second operating mode or one or more interference parameter value obtained therefrom, at least one usable frequency range, which is one that contains no detectable or detected interference oscillations such that an upper range limit of the usable frequency range and/or a lower range limit of the usable frequency range are identified based on one or more of the interference parameter values.

57. The measuring system according to claim 41, wherein the measuring system electronics are configured to check, using the at least one second sensor signal received in the second operating mode or one or more interference parameter value obtained therefrom, whether one or more mechanical resonance frequencies of the measuring transducer, or of the measuring system formed thereby, lie within a usable frequency range containing no detectable or detected interference frequencies of one or more interference oscillations and, when applicable, to output an enable message signaling this, and/or enabling the first operating mode, and/or to automatically switch to the first operating mode.

58. The measuring system according to claim 41, wherein at least one of:
the measuring system electronics are configured to vary, in the first operating mode, the signal frequency, determining the useful frequency, of the driver signal within a predetermined frequency band, which corresponds to a predetermined density measuring range of the measuring system;
the measuring system electronics are configured to set, in the first operating mode, the signal amplitude, determining an oscillation amplitude of the useful oscillations, of the driver signal so as to adjust the signal amplitude to a predetermined amplitude setpoint; and
the measuring system electronics are signal amplitude to identify the measurement values for the at least one measurement variable using the driver signal generated in the first operating mode.

59. The measuring system according to claim 41, wherein the measuring system electronics are configured to identify at least one risk frequency range containing interference frequencies of one or more interference oscillations using the at least one second sensor signal received in the second operating mode or one or more interference parameter value obtained therefrom such that an upper range limit of the risk frequency range and/or a lower range limit of the risk frequency range are identified based on one or more of the interference parameter values, and/or
wherein the measuring system electronics are configured to check, using the at least one second sensor signal received in the second operating mode or one or more interference parameter value obtained therefrom, whether one or more mechanical resonance frequencies of the measuring transducer or of the measuring system formed thereby lie within a risk frequency range containing interference frequencies of one or more interference oscillations and, when applicable, to output a warning message signaling this and/or an error report identifying one or more interference sources causing the interference oscillations, and/or to block the first operating mode at least temporarily or to deactivate the measuring system at least temporarily.

60. The measuring system according to claim 59, wherein the measuring system electronics are configured to identify, in the second operating mode, whether the useful frequency band and the risk frequency range coincide at least to some extent, and to output a warning message signaling this and/or to block the first operating mode at least temporarily or to deactivate the measuring system at least temporarily.

61. The measuring system according to claim 41, wherein the measuring system electronics are configured to subject at least the at least one second sensor signal received in the second operating mode to a spectral analysis, including a Fourier analysis and/or an analysis based on a discrete Fourier transformation, and/or
wherein the measuring system electronics are configured to perform a modal analysis for a measuring point involving the at least one vibrating element, or the measuring transducer formed thereby, at least based on the at least one second sensor signal received in the second operating mode.

62. The measuring system according to claim 41, wherein the measuring system electronics are configured to set a filter using the at least one second sensor signal received in the second operating mode or one or more interference parameter values obtained therefrom, which is set to adapt to the interference frequency spectrum of externally excited interference oscillations of the measuring system, or a measuring point formed thereby, such that the filter is configured to suppress or block interference signal components contained in the at least one second sensor signal and resulting from one or more of the interference oscillations.

63. The measuring system according to claim 62, wherein the measuring system electronics are configured to filter the first sensor signal received in the first operating mode via the filter to block interference signal components contained in the first sensor signal; and/or
wherein the filter is an adaptive filter.

64. The measuring system according to claim 41, wherein at least one of:
the at least one oscillation exciter is an electrodynamic oscillation exciter including a moving coil;
the at least one oscillation sensor is an electrodynamic oscillation sensor including a plunger coil;
the first sensor signal and the at least one second sensor signal each represent a velocity of oscillatory movements of the at least one vibrating element;
the oscillation sensor and oscillation exciter are designed to be functionally identical and structurally identical; and
the at least one oscillation sensor is spaced apart from the oscillation exciter in a direction of a flow axis of the at least one vibrating element and/or the measuring transducer formed thereby.

65. The measuring system according to claim 41, wherein the measuring system electronics are configured to identify, using the first sensor signal received in the first operating mode, one or more measuring system parameter values representing a resonance frequency of the measuring transducer or of the measuring system formed thereby, and
wherein the measuring system electronics are configured to check, using one or more non-volatilely stored, measuring system parameter value and one or more non-volatilely stored, interference parameter value, by comparing one or more interference parameter value with one or more measuring system parameter value for whether a resonance frequency of the at least one vibrating element lies within a risk frequency range containing interference frequencies of one or more interference oscillations and, when applicable, to output a warning message signaling this and/or an error report indicating one or more interference sources causing interference frequencies, and/or to deactivate the measuring system at least temporarily.

66. The measuring system according claim 45, wherein the at least one vibrating element includes at least one tube, which is at least sectionally straight and/or at least sectionally curved, such that the at least one tube is configured for the measurement substance to flow therethrough and to vibrate during this, and
wherein the useful oscillations of the at least one vibrating element excited by the at least one oscillation exciter, or identified by the at least one oscillation sensor, are at least to some extent bending oscillations of the at least one tube.

67. The measuring system according to claim 66, the at least one vibrating element includes at least one further tube such that the at least two tubes of the at least one vibrating element are connected fluidically in parallel to each other and/or are configured for the measurement substance to simultaneously flow through each and to vibrate in opposite directions during this.

68. The measuring system according to claim 67, wherein the oscillations of the at least one vibrating element excited by the at least one oscillation exciter, or identified by the at least one oscillation sensor, are at least to some extent opposing bending oscillations of the at least two tubes.

69. The measuring system according to one of claim 66, wherein the at least one oscillation sensor of the sensor arrangement includes a total of no more than twice a number of measuring tubes of the at least one vibrating element, or of the measuring transducer formed thereby, wherein each oscillation sensor is configured to detect mechanical oscillations of the at least one vibrating element and to convert each into a sensor signal representing oscillations of the at least one vibrating element, including a velocity of oscillating movements of the least one vibrating element, and/or
wherein the at least one oscillation sensor of the sensor arrangement includes a total of no more than twice the number of tubes of the at least one vibrating element, or of the measuring transducer formed thereby, wherein each oscillation sensor is configured to detect mechanical oscillations of the measuring transducer and to convert the mechanical oscillations into a sensor signal representing oscillations of the measuring transducer.

70. The measuring system according to claim 41, wherein the at least one vibrating element includes a plate-shaped or rod-shaped, immersion body configured such that the immersion body is arranged at least to some extent within a lumen of a segment of the pipe, or within a lumen of a tube of the measuring transducer inserted into the course of the pipe, and is configured for the measurement substance to flow around it and to be enabled to vibrate during this.

71. The measuring system according to claim 41, wherein the sensor arrangement includes at least one further oscillation sensor, which is structurally identical to the least one oscillation sensor and/or is electrodynamic, optoelectronic, or piezoelectric.

72. The measuring system according to claim 71, wherein at least one of:
the at least one further oscillation sensor is electrically connected to the measuring system electronics;
the at least one further oscillation sensor is configured to detect mechanical oscillations of the at least one vibrating element around a static rest position and to convert the mechanical oscillations into a sensor signal representing oscillations of the at least one vibrating element, including a velocity of oscillating movements of the at least one vibrating element;
the at least two oscillation sensors of the sensor arrangement are structurally identical;
the at least two oscillation sensors of the sensor arrangement are spaced apart from each other and arranged symmetrically with respect to an imaginary plane of symmetry of the at least one vibrating element;
the at least two oscillation sensors of the sensor arrangement are equidistant from the at least one oscillation exciter and are arranged symmetrically with respect to the imaginary plane of symmetry of the at least one vibrating element;
apart from the least one oscillation sensor and the at least one further oscillation sensor, the sensor arrangement has no further oscillation sensors configured to detect mechanical oscillations of the at least one vibrating element and to convert them into a sensor signal representing oscillations of the at least one vibrating element;
apart from the least one oscillation sensor and the at least one further oscillation sensor, the sensor arrangement has no further oscillation sensors configured to detect mechanical oscillations of the measuring transducer and to convert them into a sensor signal representing oscillations of the measuring transducer;
the at least one oscillation exciter is disposed within at least one imaginary plane of symmetry of the at least one vibrating element; and
the measuring system electronics are configured to identify measurement values of at least one measurement variable also using the first sensor signal received in the first operating mode from the at least one further oscillation sensor, including the spectral signal component with the signal frequency corresponding to the useful frequency, so as to identify a volume flow and/or a mass flow of a measurement substance flowing through the measuring transducer base on a phase difference between spectral signal components of sensor signals of each of the at least one oscillation sensor and the at least one further oscillation sensor, each with a signal frequency corresponding to the useful frequency.

73. The measuring system according to claim 41, further comprising an electronics housing for the measuring system electronics, which is attached to a transducer housing of the measuring transducer and/or is metallic, and/or
further comprising a transducer housing, which is metallic, wherein the transducer housing and the at least one vibrating element are detachably attached to each other.

74. The measuring system according to claim 41, wherein the measuring system electronics include at least one data storage element configured for non-volatile storage of digital measurement and/or operating data, including the measurement values, and/or the interference parameter values, and/or one or more measuring system parameter values.

75. The measuring system according to claim 74, wherein at least one of:
the measuring system electronics are configured to store, in the first operating mode, the measuring system parameter values in the at least one data storage element and to read out the measuring system parameter values in the first and/or second operating mode;
wherein the measuring system electronics are configured to store, in the second operating mode, the interference parameter values in the at least one data storage element and to read out the interference parameter values in the first and/or second operating mode; and
wherein the measuring system electronics are configured to store the measurement values in at least one data storage element.

76. The measuring system according to claim 41, wherein the measuring system electronics, or the measuring system formed thereby, are integrated into a superordinate electronic data processing system, which includes a programmable logic controller, and/or a process control system, and/or an edge computing device, and/or a cloud computing system, which are connected to the superordinate electronic data processing system with respect to signal and data communication.

77. The measuring system according to claim 76, wherein the measuring system electronics are configured to communicate with the superordinate electronic data processing system via a data line and/or by radio so as to activate the second operating mode and/or perform switching from the second operating mode to the first operating mode automatically and/or in dialog with an operator of the measuring system.

78. The measuring system according to claim 41, wherein the measuring system electronics include a radio unit configured to transmit measuring system data to a superordinate electronic data processing system and/or to receive process data from the superordinate electronic data processing system.

79. The measuring system according to claim 41, wherein the measuring system electronics are configured to receive a process status message generated external to measuring system electronics and transmitted to the measuring system electronics via data transmission from a superordinate electronic data processing system data-linked to the measuring system electronics and/or a display and operating element signal-linked to the measuring electronics, and/or causing activation of the second operating mode so as to activate or execute the second operating mode depending on the process status message, wherein the display and operating element is of the measuring system and/or of an operating device for the measuring system.

80. The measuring system according to claim 79, wherein the process status message indicates that the measurement substance is flowing through the measuring transducer, including with a predetermined reference volume and/or reference mass flow, and/or
wherein the process status message indicates that a pump connected to the measuring transducer is switched on.

81. The measuring system according to claim 45, wherein the first duration is more than 3 times greater than the decay time constant and/or is greater than 20 s.
